(19) United States
(12) Patent Application Publication
(10) Pub. No.: US 2012/0179991 A1
(43) Pub. Date: Jul. 12, 2012

(54) PROJECTING PROJECT OUTCOME

(75) Inventors: Trevor Howes, Hertfordshire (GB); Ben Sissons, Hampshire (GB)

(73) Assignee: BRM Fusion Ltd., Hertfordshire (GB)

(21) Appl. No.: 13/031,952

(22) Filed: Feb. 22, 2011

(30) Foreign Application Priority Data
Jan. 7, 2011 (GB) 1100215.1

(51) Int. Cl. G06F 3/048

(52) U.S. Cl. 715/771

(57) ABSTRACT

Apparatus has at least one processor and at least one memory having computer-readable code stored thereon which when executed controls the at least one processor to perform a method comprising: providing a graphical user interface (GUI); allowing a user to define, through the GUI, a project at least in terms of plural initiative components, plural outcome components, and interrelationships between the initiative components and the outcome components; allowing the user to define, through the GUI, two or more quality components for each initiative component, each quality component comprising a performance level and resource costs associated with achieving the performance level; allowing the user to define, through the GUI, plural parameters associated with the project, the parameters including performance levels and resource costs for each of at least two quality components; allowing the user to allocate, through the GUI, resources to each of the initiative components; providing a projected measure of project outcome based on the allocated resources; allowing the user to alter, through the GUI, the resources allocated to the initiative components; and providing revised projected measure of project outcome based on the altered resource allocations.

### CROSS-REFERENCE TO RELATED APPLICATIONS

The current application claims priority to Great Britain Application No. GB 1100215.1, filed Jan. 7, 2011, the disclosure of which is incorporated herein by reference.

### FIELD OF THE INVENTION

The present specification relates to projecting project outcome. In particular, although not exclusively, the specification relates to increasing the understanding, choice and management of interventions (causes) so as to maximize the value of the resultant effects.

### BACKGROUND OF THE INVENTION

To efficiently and effectively design and manage a project, a business case, a design or investment proposal or the like (hereinbelow, simply referred to as a project) a system and management method for agreeing the performance outcomes and benefits expected (effects) and what interventions are best to achieve them that are at an acceptable cost is required.

For example, when a person learns to drive a car there are common effects expected such as an increased knowledge of how to drive, the award of a license to drive and increased mobility. The causes that contribute to these effects include learning driver rules and regulations, practice at driving a car and organizing a driving test.

The contribution of the causes to each effect is important to this specification. For example, ‘learning driver rules and regulations’ may be carried out to varying levels of quality. The levels of quality of causes span from ‘not performed at all’ to the ‘optimum feasible level’, with additional levels of quality in between these two extremes. The person learning to drive has choices as to the level of quality each cause is completed to.

The level of quality each cause is completed to impacts the level of effect that could be realized. For example, ‘learning driver rules and regulations’ if not performed at all would contribute no value to the effects of increased knowledge of how to drive and therefore award of a license to drive. Likewise, ‘learning driver rules and regulations’ to the optimum level of quality would contribute the maximum possible value to the effects of increased knowledge of how to drive and therefore award of a license to drive.

The person needs to understand the causes and effects needed and how they contribute so they can make a reasoned choice. They also need to understand the different options available for causes and the different levels of quality for each option. For this example they also need to understand the resources needed for each cause and the associated risks.

It is common to base decisions on logic and intuition regarding the effects needed and therefore the causes required. In situations such as large engineering, computer, organizational and government change projects the complexity of cause and effect is significant. The complexity of factors to consider decreases the probability of sufficient effects being realized. Examples of complicating factors include the number and variety of people, organizations, professions, dependencies, constraints, risks and levels of uncertainty.

The increased development of new technologies and complex projects has also resulted in a very large number of options when creating an optimized design for a project and then managing. This has given rise to highly complex choices and the need for effective ways for creating and managing project designs so they satisfy the performance outcomes and benefits expected.

Traditional project management in the state of the art has focused on the design, delivery and management of causes. A lesser focus has been made on the clarification and definition of effects, known as benefits realization management. Understanding the contributions of value from causes to effects has been developed to a simplistic level in the state of the art.

A conventional technique is to carry out the activities of a definition unit 1b by the creation of a network diagram of nodes that represent performance outcomes and how they contribute to each other. A spreadsheet or program is used to define the measures for each performance outcome with baseline performance, expected target performance, and actual performance. On the network diagram of nodes the initiatives needed to contribute to the achievement of performance outcomes are defined. On a project plan or in a program the activities, times, dependencies and costs are captured. The risks and assumptions are also defined in a spreadsheet or program. The information from all these sources is manually or automatically collated to inform the expected benefits, activities, resources, costs, risks and timings.

In this technique to carry out the activities of an optimization unit 1c the people involved discuss the dependencies between the performance outcomes, measures, initiatives, activities, resources, timings and costs and make changes to defined information and manually or automatically collate it together so as to inform management decisions. Typically it is not possible to provide automation of the link between the capabilities expected from a project and the performance outcomes. For this reason, efficient and quantitative optimization of the trading-off the impact of changes to a project with the costs and impact on the performance outcomes cannot be easily achieved where multiple options, activities, performance outcomes and the like exist.

One example of the applicability of the concepts described herein is in understanding what a manufacturing production machine currently delivers in terms of its contribution to the outcomes of importance to the company and how this can be measured. The market value of its product, the level of waste created, its energy efficiency or its reliability are examples of such measures. The resources the machine requires to deliver the current performance level can be understood and changes to the initiatives and the possible levels of quality of each initiative identified. The impact the changes on the performance outcomes and benefits of importance to the company can be estimated and new project designs agreed.

One change considered in this example may be the purchase or build decision of new machines. Other examples can include new or existing projects, programmes, commercial product or service development and testing, the medical treatment of patients and the choices of where to place or reduce government and agency investment.

This also affects the management of teams and organizations. For example, by representing together the collection of components included in this specification, people involved in a project can understand how their contributions fit within the causes and effects. With this understanding of context then further ideas for improvement can be identified and the implications of changes better understood. This improves the performance of individuals, teams and organizations to increase the value they can add, and manage the costs, resources and risks involved.

During delivery or operation of a project then the actual and updated forecast performance may be captured and adjustments made to the causes to better meet constraints and increase the effects. If appropriate adjustments may not be made then the project may be stopped.

The importance of realizing effects and delivering the right causes is significant when people's safety, health and livelihoods are impacted. This also applies when the resources required for causes to be delivered are significant. This specification helps address these areas with different combined approach to project definition, optimization and realization.

The resources needed and lack of method and software support for optimising cause and effect designs and their delivery results in wasted resources and unsatisfactory effects being realized. There is a need to, within a set of constraints, choose a combination of causes at certain quality levels that will deliver the maximum effects of most importance. The burden on people without appropriate support to achieve this with any precision often precludes it from happening.

This specification supports, in a unique way, the definition of causes and effects, the choice of causes to deliver optimum effects within known constraints and the management of the realization of effects.

The contribution of value from the causes to the effects is important as the link between cause and effect. It is this network of contributions that influence the value delivered to customers and organizations.

There is no clear way for people to generically understand and change designs that result in a direct quantitative contribution to an end goal. As a result, the end goal has less likelihood of being achieved or it will be achieved to lower level of impact that is possible with the resources available.

Generally, there has not been an attempt made, in conventional project, business case, design or investment proposal management or the like, to define the components, techniques and methods required to optimize the multiple components they consist of in a quantitative manner and balance these against cost in a clearly distinguished manner. Increased support for the realization of performance outcomes through a system and management method for the efficient design and management of a project will increase efficiency and effectiveness in the field. This is of value given significant global application of project planning and realization and the inefficient level of resources they consume and opportunities to increase the outcomes and benefits they deliver.

### BRIEF SUMMARY OF THE INVENTION

A first aspect of the specification provides a computer-implemented method, the method comprising:

providing a graphical user interface (GUI);

allowing a user to define, through the GUI, a project at least in terms of plural initiative components, plural outcome components, and interrelationships between the initiative components and the outcome components;

allowing the user to define, through the GUI, two or more quality components for each initiative component, each quality component comprising a performance level and resource costs associated with achieving the performance level;

allowing the user to define, through the GUI, plural parameters associated with the project, the parameters including performance levels and resource costs for each of at least two quality components;

allowing the user to allocate, through the GUI, resources to each of the initiative components;

providing a projected measure of project outcome based on the allocated resources;

allowing the user to alter, through the GUI, the resources allocated to the initiative components; and

providing revised projected measure of project outcome based on the altered resource allocations.

Allowing the user to alter, through the GUI, the resources allocated to the initiative components may involve allowing the user to select one of a number of items, for instance an intervention component, a capability component or a quality component, associated with the initiative component, each item having associated resource costs.

Optionally, at least one of the outcome components is defined to includes inputs from at least two initiative components and/or outcome components, the method comprising allowing the user to define, through the GUI, parameters that define contributions to the outcome component that are provided by the initiative components and/or outcome components connected to the inputs of the at least one outcome component; and allowing the user to alter, through the GUI, the parameters.

The resource costs associated with at least one quality component may include a time component. Here, the time component may be a duration relating to the time necessary to deliver capability, to the time necessary to maintain the capability once delivered where it would otherwise reduce, or to dose down the capability or interventions in an acceptable way.

The method may comprise allowing the user to define, through the GUI, a plan for each of at least one quality component, the plan comprising multiple components each having associated therewith at least a resource cost. The method may comprise, subsequent to providing a projected measure of project outcome based on the plural parameters, allowing the user to change one or more of the multiple components of the plan.

Allowing the user to alter, through the GUI, one or more of the plural parameters associated with the project may comprise allowing the user to alter, through the GUI, one or more resource cost parameters.

The method may comprise, subsequent to providing a projected measure of project outcome based on the plural parameters, allowing the user to add, through the GUI, at least one new initiative component and one or more interrelationships between the new initiative component and the existing initiative components and the existing outcome components. Here, allowing the user to add a new initiative component may comprise allowing the user to choose, through the GUI, at least one initiative component from a library of initiative components. The library may be locally generated, or may be obtained from an external source. Alternatively, a user may be allowed to create a new initiative component without reference to existing initiative components.

The method may comprise, subsequent to providing a projected measure of project outcome based on the plural parameters, allowing the user to add, through the GUI, at least one new quality component to an existing initiative component, each new quality component comprising a performance level and resource costs associated with achieving the performance level.

The method may comprise allowing the user to specify, through the GUI, a measure of projected outcome, and adjusting one or more of the plural parameters associated with the project so as to achieve the specified measure of project outcome at minimum resource cost.

The method may comprise allowing the user to specify, through the GUI, a resource cost, and adjusting one or more of the plural parameters associated with the project so as to achieve an optimum measure or project outcome at the specified resource cost.

Optionally, a measure component is associated with each of one or more of the plural outcome components, each measure components including information detailing how to measure outcome of the corresponding outcome component.

The specification also provides a computer program, optionally stored on a computer readable medium, that when executed by computer apparatus controls it to perform a method as recited above.

A second aspect of the specification provides apparatus, the apparatus having at least one processor and at least one memory having computer-readable code stored thereon which when executed controls the at least one processor to perform a method comprising:

providing a graphical user interface (GUI);

allowing a user to define, through the GUI, a project at least in terms of plural initiative components, plural outcome components, and interrelationships between the initiative components and the outcome components;

allowing the user to define, through the GUI, two or more quality components for each initiative component, each quality component comprising a performance level and resource costs associated with achieving the performance level;

allowing the user to define, through the GUI, plural parameters associated with the project, the parameters including performance levels and resource costs for each of at least two quality components;

allowing the user to allocate, through the GUI, resources to each of the initiative components;

providing a projected measure of project outcome based on the allocated resources;

allowing the user to alter, through the GUI, the resources allocated to the initiative components; and

providing revised projected measure of project outcome based on the altered resource allocations.

The computer-readable code may, when executed control the at least one processor to provide a definition module, a realization module and an optimization module.

Here, the definition unit may be configured to perform one or more of:

manage definitions of the performance outcomes and how their achievement will be measured;

manage definitions of the interventions needed to create the capabilities for the performance outcomes to be achieved; and

manage definitions of different ways in which interventions and capabilities can be delivered to different levels of quality.

Alternatively or in addition, the definition unit may be configured to obtain definitions of forecast durations, resources and costs of the interventions, and optionally also of sequential relationships between interventions that result in a change in capability.

Alternatively or in addition, the definition unit may be configured to obtain definitions of the performance outcomes and their relative importance.

Optionally, at least one of the outcome components is defined to includes inputs from at least two initiative components and/or outcome components, and where the computer-readable code when executed controls the at least one processor to allow the user to define, through the GUI, parameters that define contributions to the outcome component that are provided by the initiative components and/or outcome components connected to the inputs of the at least one outcome component; and to allow the user to alter, through the GUI, the parameters.

A third aspect of the specification provides a non-transitory computer-readable storage medium having stored thereon computer-readable code, which, when executed by computing apparatus, causes the computing apparatus to perform a method comprising:

providing a graphical user interface (GUI);

allowing a user to define, through the GUI, a project at least in terms of plural initiative components, plural outcome components, and interrelationships between the initiative components and the outcome components;

allowing the user to define, through the GUI, two or more quality components for each initiative component, each quality component comprising a performance level and resource costs associated with achieving the performance level;

allowing the user to define, through the GUI, plural parameters associated with the project, the parameters including performance levels and resource costs for each of at least two quality components;

allowing the user to allocate, through the GUI, resources to each of the initiative components;

providing a projected measure of project outcome based on the allocated resources;

allowing the user to alter, through the GUI, the resources allocated to the initiative components; and

providing revised projected measure of project outcome based on the altered resource allocations.

Broadly, embodiments of the present specification enable the trade-off between the costs of delivering capability and the impact of the capability on performance outcomes (cost-capability trade-off) when designing, optimizing and managing a project to increase efficiency and effectiveness thereof.

The manual development and delivery of project design components by multiple groups is not efficient or effective given the variability of language use, expectations and also need to consider other qualities a design component may have, for example its potential cost and the value it adds to the overall performance outcomes.

This specification provides descriptors of components that are representative. The elements of a project design may be newly created for each design, existing elements may be re-used, variants of existing elements may be created, or any combination of these three may apply.

Descriptors used in the project design enable a full set of calculations to be made. If values for all the descriptors within the design are omitted, this impacts the calculations yet does not invalidate the value of the design descriptor.

Embodiments of the present specification are placed particularly in the context of seeking descriptors that are compact and robust to changes in project design preferences, for example the reframing of the importance of a design component in meeting the performance outcome.

Features of the embodiments make it possible to calculate a descriptor that is based on the content and that takes into account the characteristics of the design component, the positioning of the design component in the overall project design and any time periods related to the design component is active for.

The time period dimension can allow greater robustness of the match of the design component to the performance outcomes to increase the suitability of the project design.

Broadly, embodiments of the present specification enable complicated project designs to be defined, optimized and realized. Embodiments also allow increased involvement with people to gain insight on and agree the objectives of a project design and the benefits expected from it. The embodiments also allow the collaboration of people and teams around creating all the interventions needed to design, build, deliver and operate the project design. Also allowed is the ability to understand the impact of trading-off the cost of a project design with the capability and benefits it delivers. The embodiments also allow simpler management of cost, time, risk and benefits of a project design throughout any or all of its design, build, deliver and operate stages.

Embodiments may be configured as a system that includes a definition unit 1b, an optimization unit 1c and a realization unit 1d.

The definition unit 1b may obtain definitions of the performance outcomes and how their achievement will be measured; the interventions needed to create the capabilities for the performance outcomes to be achieved; and the choices available in which the interventions and capabilities can be delivered to different levels of quality.

Moreover, the definition unit 1b may obtain definitions of the forecast durations, resources and costs of the interventions and of sequential relationships between interventions that result in a change in capability. The change in capability may result in different levels of value being created that contribute to the achievement of the performance outcomes.

Furthermore, the definition unit 1b may obtain definitions of the performance outcomes and their relative importance. Definitions of how achievement of the performance outcomes will be measured and the expected levels of performance expected may be obtained.

One simple example that may aid understanding of the significance of embodiments is for the manufacturing sector in terms of understanding the level of current performance of an existing machine and improving the value it adds to the outcomes of importance to the company (its performance level). Firstly, it is possible to understand what the machine currently delivers in terms of its contribution to the outcomes of importance to the company and how this can be (or is) measured (for example, the market value of its product, the level of waste created, its energy efficiency or its reliability). It is possible also to understand the resources, time and risk of the interventions needed to deliver the current performance level and then consider improvements. Improvements that can be considered, in a structured way, include what initiatives and choices within each initiative (i.e. the level of quality) could be delivered and the impact each of these are expected to have on the outcomes of importance to the company. By understanding the resources, time and risk of the interventions needed to deliver the levels of quality identified, the cost, effort, time and risk associated with the increase in quality can be balanced against the incremental benefits and decisions made. The results can allow a user of the system, e.g. a project planner of project manager, to make a determination as to whether it is worth progressing with one option compared with other choices.

This application to the manufacturing sector may also be applied to multiple areas where decisions are required, for example for the purchase or build decision of new machines. It can also be applied to new or existing projects, programmes, pharmaceutical drugs, medical treatment of patients, commercial products and the choices of where to place investments by governments and their agencies.

The optimization unit 1c may obtain sequence and choice information on the possible levels of quality that the interventions and capabilities may be delivered to. The impact of the different levels of quality on meeting the performance outcomes may be obtained as well as the impact on how they may be measured.

Moreover, the optimization unit 1c may obtain the costs of delivering the interventions and capabilities. This may be defined over time periods.

Furthermore, the optimization unit 1c may generate information on the impact of making changes to the interventions to show changes in meeting the performance outcomes. The optimization unit 1c may also generate information on the impact on the levels of cost. Constraints may be defined for the interventions to constrain the possible changes to interventions. Optimization criteria may be obtained to compare the effect of changes to interventions, capabilities and levels of quality on the performance outcomes specified in the optimization criteria.

The realization unit 1d may obtain definitions of the actual durations, resources and costs and the impact of them on the changes in meeting the performance outcomes may be measured.

Moreover, changes to the interventions, definitions of the forecast durations, resources and costs of the interventions and of sequential relationships between interventions that result in a change in capability may be obtained by the realization unit 1d. Changes to the choices available in which the interventions and capabilities may be delivered to different levels of quality may also be obtained.

Furthermore, the realization unit 1d may obtain changes to the definitions of the performance outcomes and their relative importance. Changes to the definitions of how achievement of the performance outcomes may be measured and the expected levels of performance expected may be obtained. The impact of changes and the level of capability on the performance outcomes and measures may be generated.

In addition, the system may have a configuration unit which further includes detailed definition information defining a detailed item to be considered depending on the type of component and the relationship between the components. In this case, the optimization unit 1c registers the corresponding detailed definition information in the data structure on the basis of the information on the component registered in the data structure.

Embodiments of the present specification can also be implemented in the form of a method. Moreover, the specification can also be implemented as a program for implementing the functions of the above-described system using a computer. The program can be provided by distributing a magnetic disk, an optical disk, a semi-conductor memory or a different computer readable storage medium in which the program is stored, or delivering a program through a network.

### BRIEF DESCRIPTION OF THE DRAWINGS

Embodiments will now be described, by way of example only, with reference to the accompanying drawings, in which:

FIG. 1 is a diagram showing a configuration of a project design optimization and realization system according to one embodiment;

FIG. 2 is a diagram showing an example of a hardware configuration of a computer which implements the software application shown in FIG. 1.

FIG. 3 is a diagram showing an example of instances of performance outcomes and contribution weightings.

FIG. 4 is a parametric diagram showing a configuration example of components, contributions and contribution weightings for a service desk project through the application software GUI.

FIG. 5 is a parametric diagram that adds intervention, capability and quality components to FIG. 4.

FIG. 6 is a table showing an example of resource and cost information for an intervention from FIG. 5.

FIG. 7 is a table showing an example of performance level information for a set of quality components from FIG. 5.

FIG. 8 is a table showing an example of the definition of measure performance for a set of performance measures through the application software GUI.

FIG. 9 is a table showing example instances of phases through the application software GUI.

FIGS. 10a and 10b are tables showing the selection of qualities to be achieved over defined phases and the impact this has on the performance level outcomes, measures and measure performance through the application software GUI.

FIG. 11 is a table showing an additional example of the definition of measure performance for a set of performance measures through the application software GUI.

FIG. 12 is a block diagram showing the main components of the specification.

FIG. 13 is a block diagram showing a relationship between performance outcome components.

FIG. 14 is a table showing the relationship between measure performance levels and measure units.

FIG. 15 is a block diagram showing measure component descriptors.

FIG. 16 is a block diagram showing a one-to-many relationship between initiative and performance outcome components.

FIG. 17 is a block diagram showing a many-to-one relationship between quality components and initiative components.

FIG. 18 is a table showing performance levels on instances of quality components.

FIG. 19 is a block diagram showing a many-to-one relationship between capability components and quality components.

FIG. 20 is a block diagram showing a relationship between intervention components.

FIG. 21 is a block diagram showing relationships from performance outcome components to performance outcome components using the contribution weighting component relationship.

FIG. 22 is a block diagram showing relationships from initiative components to performance outcome components using the contribution weighting component relationship.

FIG. 23 is a block diagram showing example contribution types.

FIG. 24 is a parametric diagram using a product contribution type grouping to show the calculation of performance levels from quality components to performance outcome components.

FIG. 25 is a parametric diagram using a minimum (constraint) contribution type grouping to show the calculation of performance levels from quality components to performance outcome components.

FIG. 26 is a parametric diagram using a maximum (substitution) contribution type grouping to show the calculation of performance levels from quality components to performance outcome components.

FIG. 27 is a parametric diagram using an average contribution type grouping to show the calculation of performance levels from quality components to performance outcome components.

FIG. 28 is a parametric diagram using a maximum (substitution) contribution type grouping and an inverse accumulation contribution type to show the calculation of performance levels from quality components to performance outcome components.

FIG. 29 is a parametric diagram using a maximum (substitution) contribution type grouping with an included inverse maximum (substitution) contribution type to show the calculation of performance levels from quality components to performance outcome components.

FIG. 30 is a parametric diagram using an inverse maximum (substitution) contribution type grouping and an inverse accumulation contribution type to show the calculation of performance levels from quality components to performance outcome components.

FIG. 31 is a flowchart showing the details of processing shown in FIG. 1 performed by a definition unit.

FIG. 32 is a flowchart showing the details of processing shown in FIG. 1 performed by an optimization unit.

FIG. 33 is a flowchart showing the details of comparison processing shown in FIG. 1 performed by an optimization unit.

FIG. 34 is a flowchart showing the details of processing shown in FIG. 1 performed by a realization unit.

FIG. 35 is a table showing an example of intervention, capability, quality, initiative and performance outcome information.

FIG. 36 is a table showing intervention resource information for the intervention components from FIG. 35 and performance level information for the quality components from FIG. 35.

FIG. 37 is a table showing contribution weighting information, measure components and measure performance information for information from FIG. 35 and FIG. 36.

FIG. 38 is a table showing intervention resource information for interventions from FIG. 36.

FIGS. 39a and 39b are tables showing example phase component information, with FIG. 39b being the view of the phase through the application software GUI

FIG. 40 is a table showing the selection and linking of qualities to be achieved either before, during or after specific project phases. It uses the phases from FIG. 39 and quality and initiative component information from FIG. 37.

FIG. 41 is a diagram showing the calculation of performance levels for performance outcomes using the contribution weightings from FIG. 37.

FIG. 42 is a table showing selected qualities and their costs and performance levels using on FIG. 41 performance information and cost information from FIG. 38.

FIG. 43 is a table showing an example of expected measures from performance levels using information from FIG. 42 and FIG. 37.

FIG. 44 is a table showing overall cost and benefit calculations for the performance outcome O-4 from FIG. 46. It uses information from FIG. 36, FIG. 37, FIG. 41 and FIG. 42.

FIG. 45 is a table that shows the impact of a 1% change in performance level on a quality from FIG. 44.

FIG. 46 is a parametric diagram showing key components and contributions viewed through the GUI.

FIG. 47 is a table showing the entry of an intervention resource component through the GUI.

FIG. 48 is a parametric diagram based on FIG. 46 with contribution weightings and the performance level of qualities viewed through the GUI.

FIG. 49 is a table showing how the performance levels of a quality are edited through the GUI.

FIG. 50 is a flowchart illustrating operation of the FIG. 2 system in summary.

### DETAILED DESCRIPTION OF PREFERRED EMBODIMENTS

The following detailed description is of the best currently contemplated modes. The description is not to be taken in a limiting sense, but is made merely for the purpose of illustrating the general principles, and the scope of the invention is defined only by the appended claims and their equivalents.

Embodiments herein provide a software application, also referred to herein as a program that is usable by a user, such as a project planner or project manager to assist them in project design and project execution. The software is executed on computing apparatus, which may be a general purpose computer.

As a program the user is presented with a GUI that allows them to define a project with all the required components. The components enable a project design and consist of those representing causes, effects and supporting elements. Components are defined and optimized in a manner that the impact on the performance outcomes can be measured. Put succinctly, the software provides a computer-implemented method which comprises plural steps. Some key steps will now be described. The method firstly allows a user to define, through the GUI, a project at least in terms of plural initiative components, plural outcome components, and interrelationships between the initiative components and the outcome components. The method then allows the user to define, through the GUI, two or more quality components for each initiative component, each quality component comprising a performance level and resource costs associated with achieving the performance level. The method then allows the user to define, through the GUI, plural parameters associated with the project, the parameters including performance levels and resource costs for each of at least two quality components. Subsequently, the method allows the user to allocate, through the GUI, resources to each of the initiative components. Then, the method provides a projected measure of project outcome based on the allocated resources. Afterwards, the method allows the user to alter, through the GUI, the resources allocated to the initiative components. Finally, the method provides a revised projected measure of project outcome based on the altered resource allocations.

### System Configuration

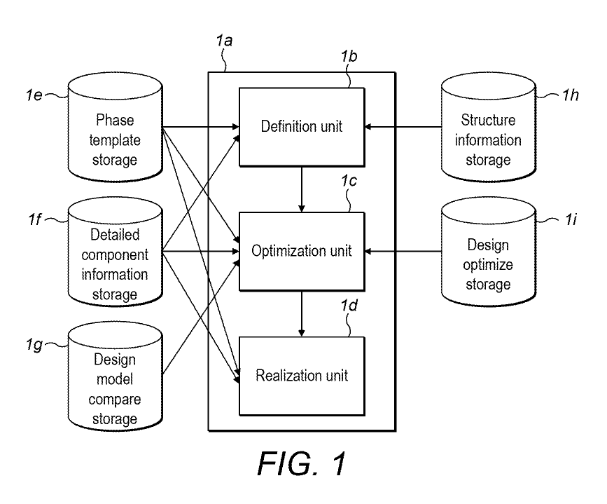

FIG. 1 is a diagram showing a configuration of a project design optimization and realization system according to one embodiment. The system is implemented by the software application mentioned above, which will hereafter be referred to as project design software 1.

The project design software 1 shown in FIG. 1 includes: a design optimization and realization generator 1a, a phase template storage 1e, a detailed component information storage 1f, a design model compare storage 1g, a structure information storage 1h and a design optimize storage 1i. Moreover, the design optimization and realization generator 1a includes: a definition unit 1b, an optimization unit 1c and a realization unit 1d.

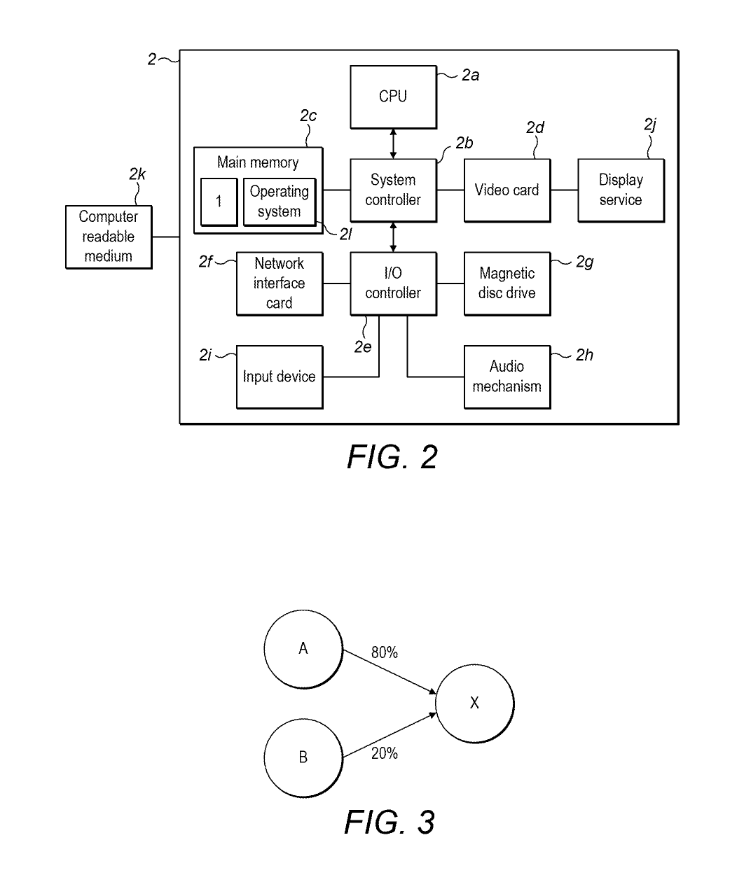

FIG. 2 is a diagram showing an example of a hardware configuration of a computer which implements the design optimization and realization system shown in FIG. 1.

A computer 2 shown in FIG. 2 includes a CPU (central processing unit) 2a, which is computing means, and a main memory 2c and a magnetic disk drive (hard disk drive (HDD)) 2g, which are storage means. The computer 2 also includes a network interface card 2f for connecting the computer 2 to an external device via a network, a video card 2d and one or more display devices 2j for display output, and an audio mechanism 2h for audio output. Moreover, the computer 2 further includes an input device 2i such as a keyboard and/or a mouse.

As shown in FIG. 2, the main memory 2c and the video card 2d may be each connected to the CPU 2a through a system controller 2b. The network interface card 2f, the magnetic disk drive 2g, the audio mechanism 20h and the input device 2i may be each connected to the system controller 2b through an input/output (I/O) controller 2e. Each of the above-described components may be connected through various busses such as a system bus and an I/O bus. For example, the CPU 2a and the main memory 2c may be connected through a system bus and a memory bus. The CPU 20a and each of the magnetic disk drive 2g, the network interface card 2f, the video card 2d, the audio mechanism 2h, the input device 2i and the like may be connected through an I/O bus such as a peripheral components interconnect (PCI), a PCI Express, a serial. AT attachment (SATA) a universal serial bus (USB) and an accelerated graphics port (AGP). The main memory 2c stores both an operating system 2l and the project design software 1.

Briefly, the CPU 2a operates as permitted and controlled by the operating system 2l. The operating system oversees and facilitates execution of the project design software 1 by the CPU 2a. The project design software 1 contains instructions that are executed by the CPU 2a so as to cause the computer 2 to perform the functions provided by the project design software 1.

The project design software 1 and/or the operating system 2l may arrive at the computer 2 in any suitable way, for instance by being loaded into the computer 2 from a computer readable medium 2k, which may for instance be an optical storage medium, such as a CD or DVD, a magnetic medium, such as a floppy disk, FLASH memory, or any other suitable medium.

It should be noted that FIG. 2 only shows an example of a computer hardware configuration which is suitable for the application of one embodiment, and it goes without saying that computing apparatus, e.g. a server computer, to be actually used is not limited to the configuration shown in FIG. 2. For example, a configuration to be employed may be such that image data can be processed by the CPU 2a by providing the computer with only a video memory, instead of the video card 2d. Moreover, instead of the configuration of including the audio mechanism 2h independently, a configuration may also be employed such that the audio mechanism 2h can be included as a function of a chip set composing the system controller 2b and the I/O controller 2e. Furthermore, in addition to the magnetic disk drive 2g, drives employing various optical disks and flexible disks as media may also be provided as auxiliary storage devices. As the display device 2j, a liquid crystal display may be normally used, but any kind of display such as a cathode ray tube (CRT) display or a plasma display may be used instead. It will be appreciated that the software could be executed by a server or system or servers in a cloud environment and accessed by users through client devices.

In the case where the design optimization and realization system shown in FIG. 1 is configured by the computer shown in FIG. 2, each function of the design and delivery generator 1a may be performed in a manner that the CPU 2a executes a program read out from the main memory 2c.

Moreover, the phase template storage 1e, a detailed component information storage 1f, a design model compare storage 1g, a structure information storage 1h and a design optimize storage 1i can be implemented by storage means such as the main memory 2c and the magnetic disk drive 2g.

The phase template storage 1e stores therein a template (definition information) showing a sequence structure of each capability delivery and realization stage of a project, business case, design or investment proposal or the like.

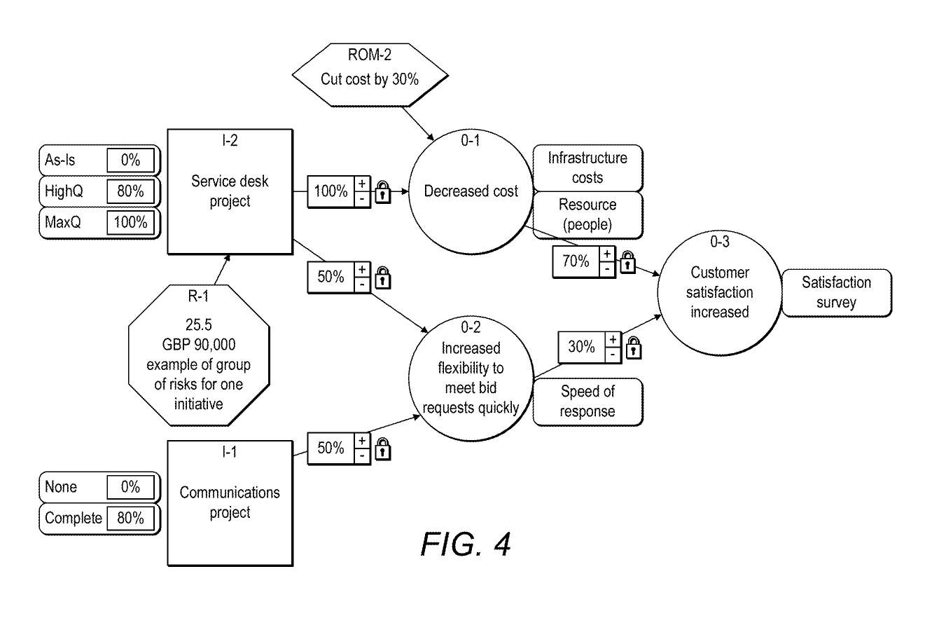

Those components that represent the effects are shown in FIG. 4. Using the GUI of the project design software 1, the user creates performance outcomes (represented by circular shapes) and adds links between them to reflect contributions. Where more than one contribution is linked to a performance outcome then the value of each contribution weighting can be set by the user. In this example, a Decreased Cost outcome component O-1 has a greater contribution weighting (70%) to Customer Satisfaction Increased outcome component O-3 than the 30% from an Increased Flexibility To Meet Bid Requests Quickly outcome component O-2.

Each performance outcome component may have a number of measure components linked to store attributes of forecast and actual performance measure data. Infrastructure costs and Resource (people) are two measure components linked to measure performance outcome O-1.

A Service Desk Project initiative component I-2 provides performance level data to the Decreased Cost outcome component O-1 and the Increased Flexibility to Meet Bid Requests Quickly outcome component O-2. Linked to the initiative component are three quality components As-Is, HighQ and MaxQ. As-Is represents no change, MaxQ represents the maximum quality improvement from this initiative with 100% performance level and HighQ represents 80% of the maximum performance level improvement level.

An example requirement component and risk component are also shown as supporting elements with the risk component having a calculated risk score of 25.5 and an estimated risk value of £90,000.

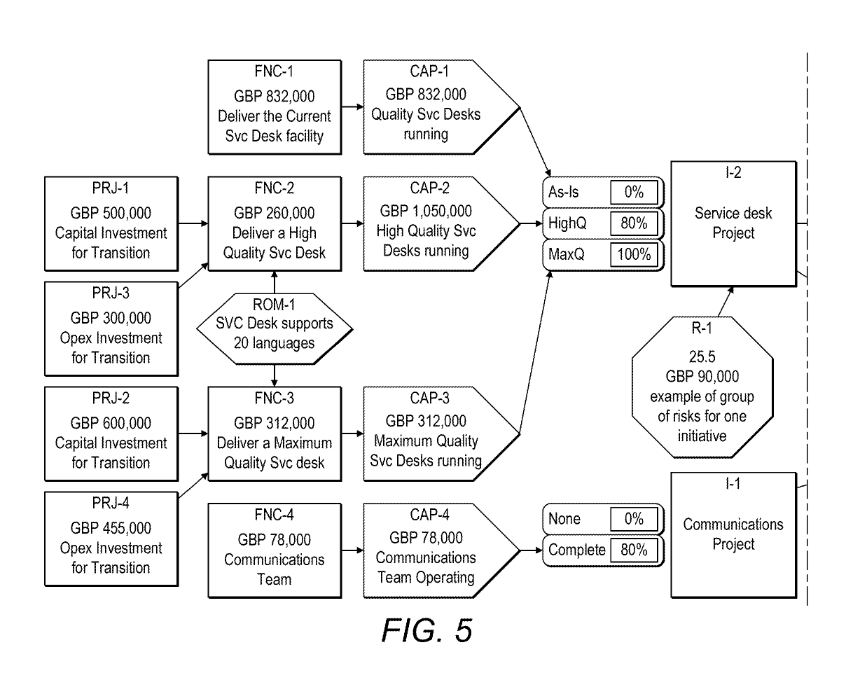

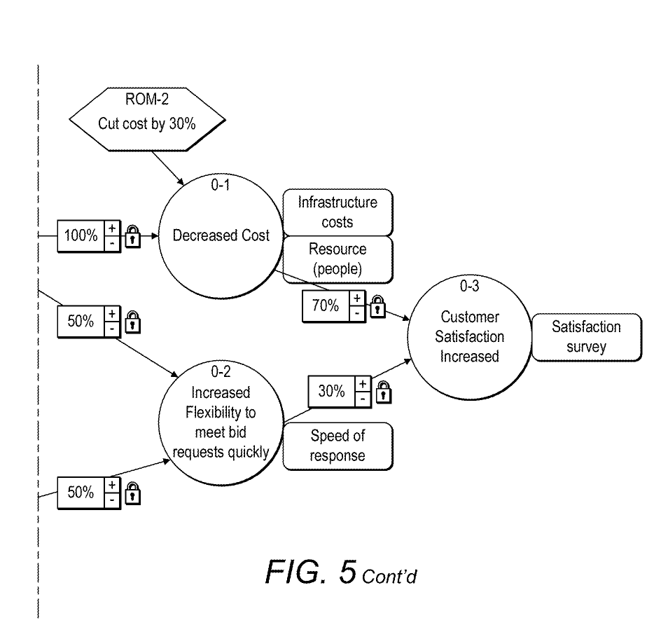

Examples of some of the components that represent the causes are shown in FIG. 5. These represent three different choices of quality for the initiative—a current service desk CAP-1, a transition to and running of a high quality service desk CAP-2 or a transition to and running of a maximum quality service desk CAP-3.

The capability components, linked into the quality components, represent the change in capability the intervention components deliver. The capability component also has a calculated cumulative cost figure of the intervention components linked to it.

Two types of Intervention component are shown in FIG. 5. Project and Structure intervention types of Intervention component are labelled PRJ-1 to PRJ-4 and Function intervention types of Intervention component are labelled FNC-1 to FNC-3.

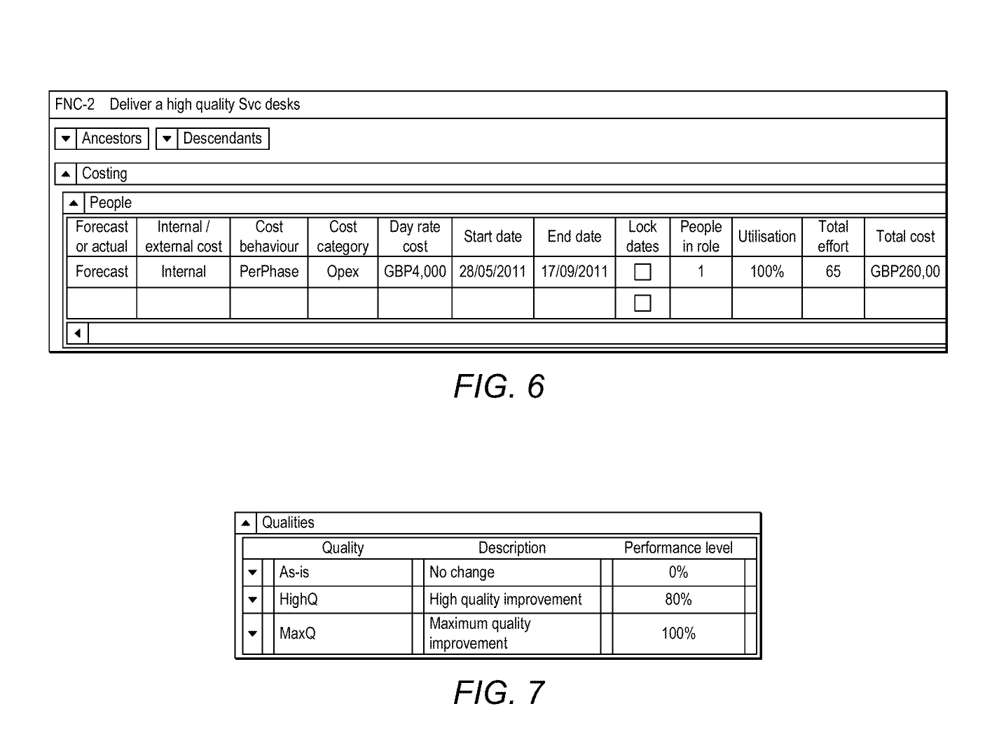

The user can define each components data by editing them in the project design software 1. For example, the Intervention Resource components that are linked to each Intervention component may have values stored in them using a template such as that shown in FIG. 6. The Maintain type resource component is shown in FIG. 6 and is referred to as PerPhase.

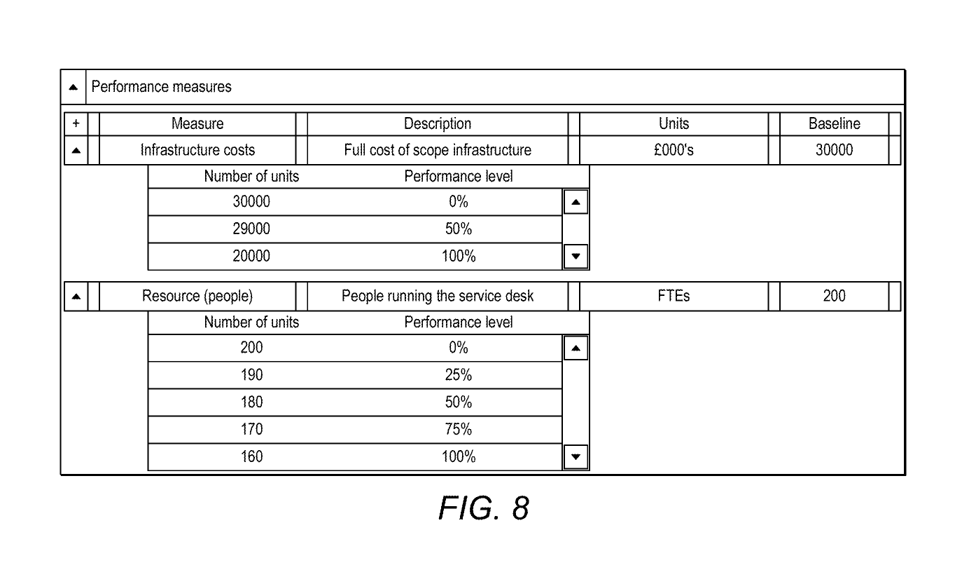

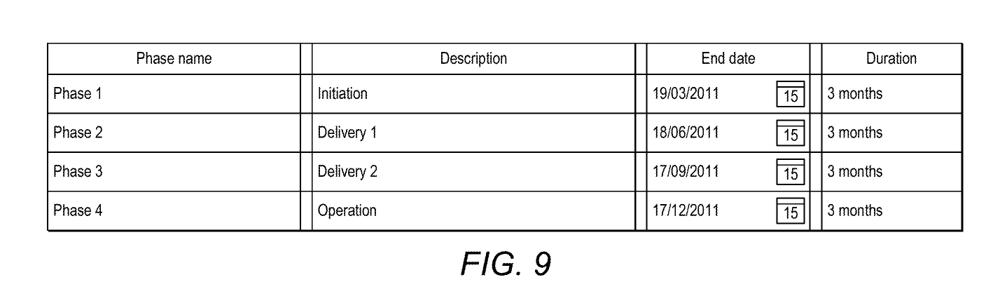

For the Quality components, the data can be defined by the user as shown in FIG. 7 and for the Measure component an example of O-1 is shown in FIG. 8. For the Phase components an example view of how these are entered are shown in FIG. 9 with four phases shown.

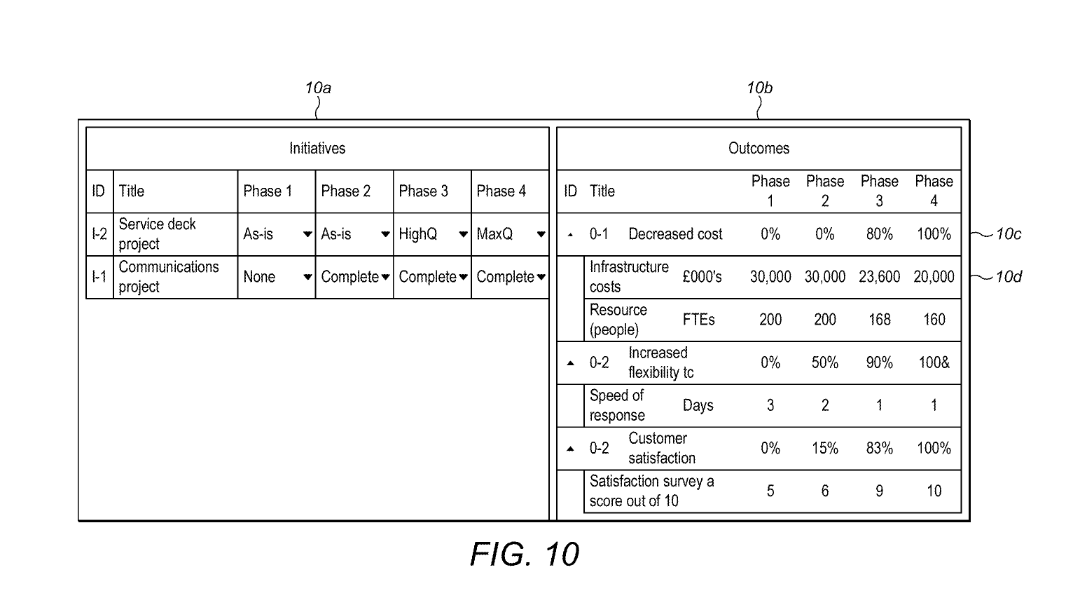

The timing of performance levels is configured through the GUI when the Quality components are linked to specific Phase Components. FIG. 10a shows the Initiative Component I-1 and the Quality components linked to it also being linked to the Phase components. This results in the performance level generated by the Quality component to be released through the network of Performance Outcome components. As shown in FIG. 10b, the Performance Outcomes O-1 to O-3 have their performance level released into it as shown, from 0% to 100% across the phases.

In Phase 3 (FIG. 10) the performance levels of 80% from the HighQ and 100% from the Complete Quality components flow into O-2 (FIG. 5). All the contribution types are of accumulation and so the value flowing into the performance outcome component O-2 is calculated as 50% of 80% (40%) from HighQ and 50% of 100% (50%) from Complete Quality components. 90% is the performance level in the performance outcome component O-2.

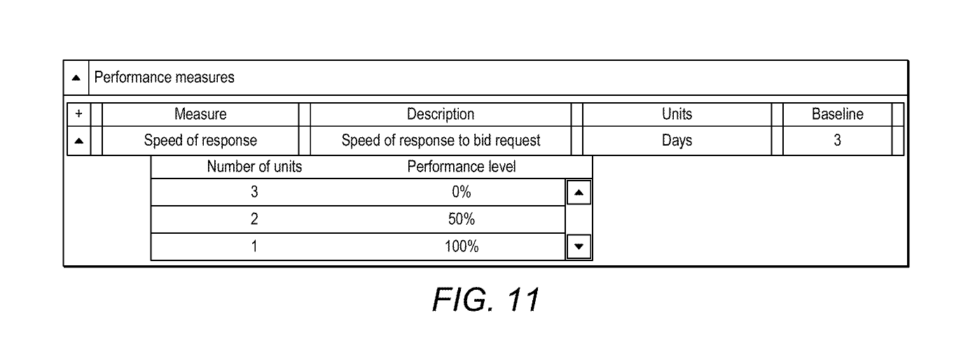

The Measure component linked to O-2 in FIG. 11 shows that, for a performance level of 80%, the equivalent unit for the measure is 1. This value is shown in FIG. 10. The same logic is applied for all the measures, for example in FIG. 10 in Phase 3 the performance level of 80% is stored in the performance outcome component O-1. In FIG. 8 for the Resource component this 80% has the equivalent units of 168 and this is shown in FIG. 10.

When the user, through the GUI, changes one or more parameters of contribution weightings, performance levels on Quality components or their phasing, the units and performance levels on Measure components or the type of contributions, algorithms of the project design software Tare run and the project design software 1 provides expected benefits based on the changed parameters.

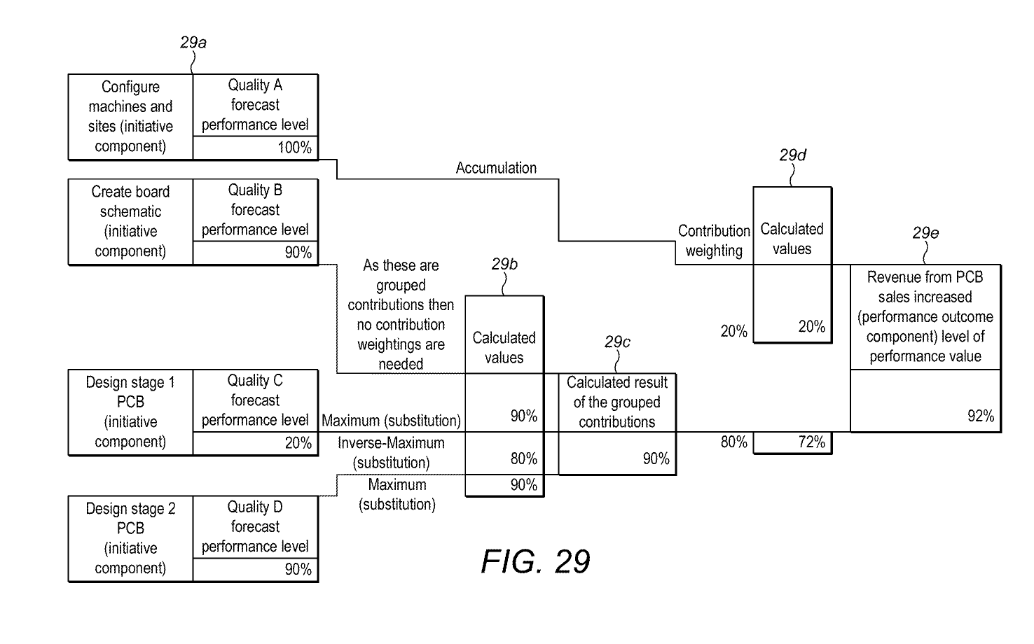

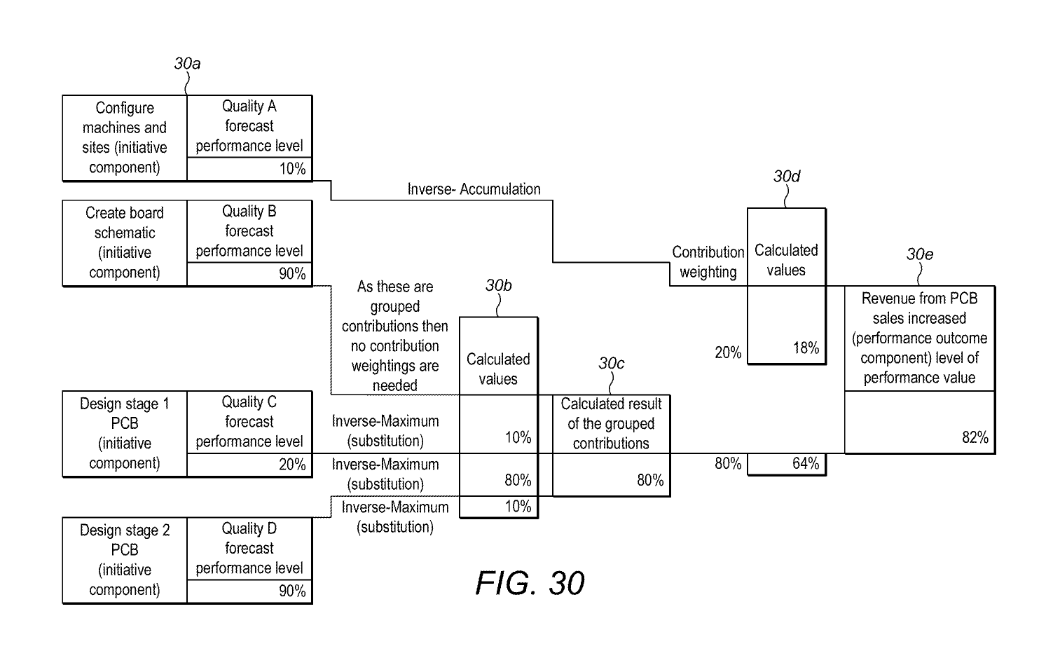

Resource Costs are also calculated based on the durations of the phases to which a Quality component is linked. For example, Deliver a High Quality Svc Desk FNC-2 is linked to the HighQ Quality component (FIG. 29). HighQ is linked to Phase 3 (FIG. 30c) which is between the dates of Jun. 18, 2011 and Sep. 17, 2011 (FIG. 9). Therefore, the start and end dates on Deliver a High Quality Svc Desk FNC-2 in FIG. 6 match that of the Phase to which it is linked. If it was linked to Phase 4 as well, then the end date would extend to the end of Phase 4. The Total effort and Total cost on FIG. 6 would change accordingly. The dates on FNC-2 would also change if the Phase start and end dates were changed.

The interlinking in a network enables the project costs and benefits to be automatically recalculated and compared for highly complex projects. This is currently not possible with this degree of efficiency and engagement with the people sponsoring, managing, delivering or affected by a project.

FIG. 9 is a table showing a configuration example of a phase template.

In the phase template shown in FIG. 9, phase names for identifying each phase, phase sequence numbers for showing the execution sequence of each phase and the phase start and end dates for identifying the time periods for each phase may be items to be registered. According to the phase template shown in FIG. 9, the project, business case, design or investment proposal or the like progresses through four phases, phase A, phase B, phase C and phase D in this order. Various templates may be stored in the phase template storage 1e according to the type of project, business case, design or investment proposal or the like.

The structure information storage 1f stores therein a structure model which is information on the component and relationship structure for the project to be developed and managed. A standard component and relationship structure may have components added or their characteristics or their properties changed to enhance the project design, optimization or realization. Likewise, the standard component and relationship structure may have relationships added or their characteristics or properties changed to enhance the project design, optimization or realization. Various reasons may support additions or changes, for example, the capturing of additional relationships between components and properties of components to meet analysis or reporting or a given situation.

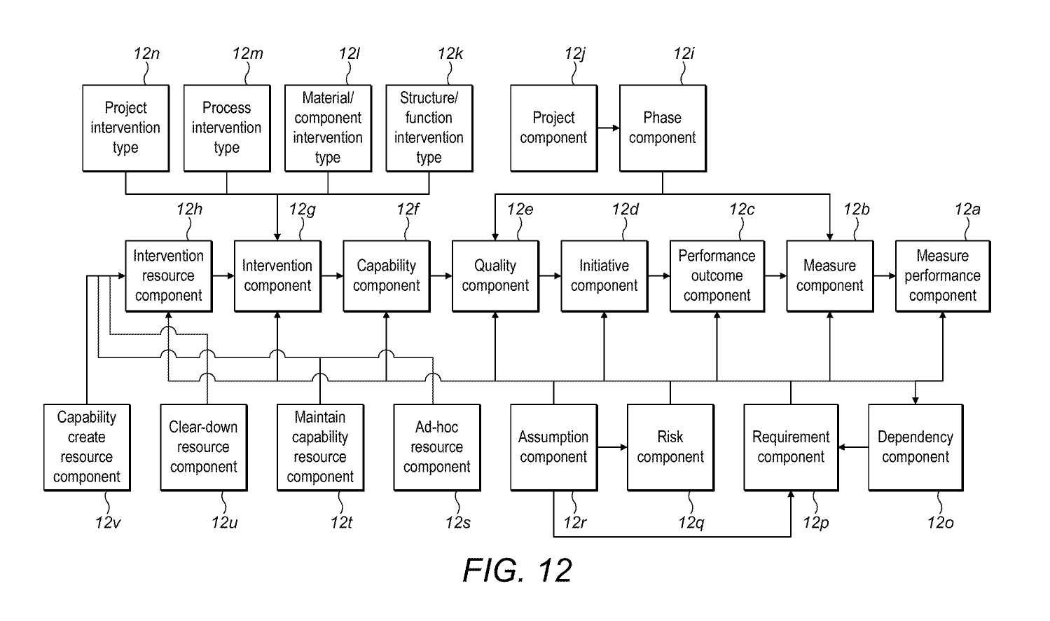

FIG. 12 is a diagram showing an example of a structure information storage model.

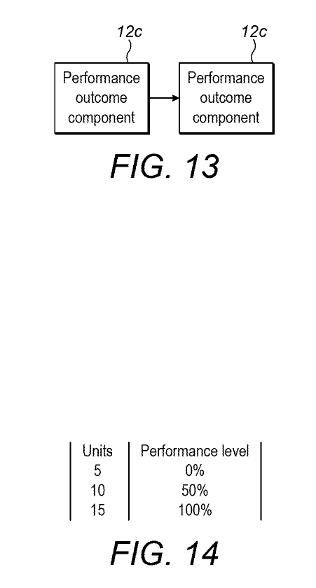

FIGS. 13 to 23 are sub-diagrams for the example structure information storage.

A performance outcome component may be part of a network of other performance outcome components, as shown in FIG. 13. An example is that a performance outcome of ‘fewer process steps’ may link to a performance objective of ‘less resources used’, as the former contributes to achievement of the latter. The latter may link to a performance objective of ‘lower costs’ as this is contributed to by the achievement of ‘less resources used’. These performance outcome components may have detailed supporting information that describes the characteristics of the performance outcome component. These characteristics may be shared with other performance outcome components or may be unique to it. These characteristics, for example, if it is a strategic or performance outcome of special significance may be used in one embodiment of the design to change the characteristics of the performance outcome component when displayed or represented. For example, ‘lower costs’ may be of a higher significance than others and therefore represented differently to demonstrate its difference.

As shown in FIG. 12, a measure component 12b may have one or more measure components 12a to enable levels of expected or actual levels of achievement of the measure to be represented.

An example of multiple measure components is shown in FIG. 14 with a performance level of 0% representing no change to current performance and 100% the maximum change. For this example the measure component is ‘number of enquires that can be processed in an hour’, the first performance component at 0% is the current performance with 5 enquires. For 50% of value, the performance measure is the processing of 10 enquiries and for the maximum 100% then it is 15 enquires per hour.

Each performance outcome component 12c may have associated therewith any number of measure components 12b. For example, a performance objective of ‘increased throughput’ may have two measure components of ‘number of enquiries that can be processed in an hour’ and ‘number of orders that can be processed in an hour’.

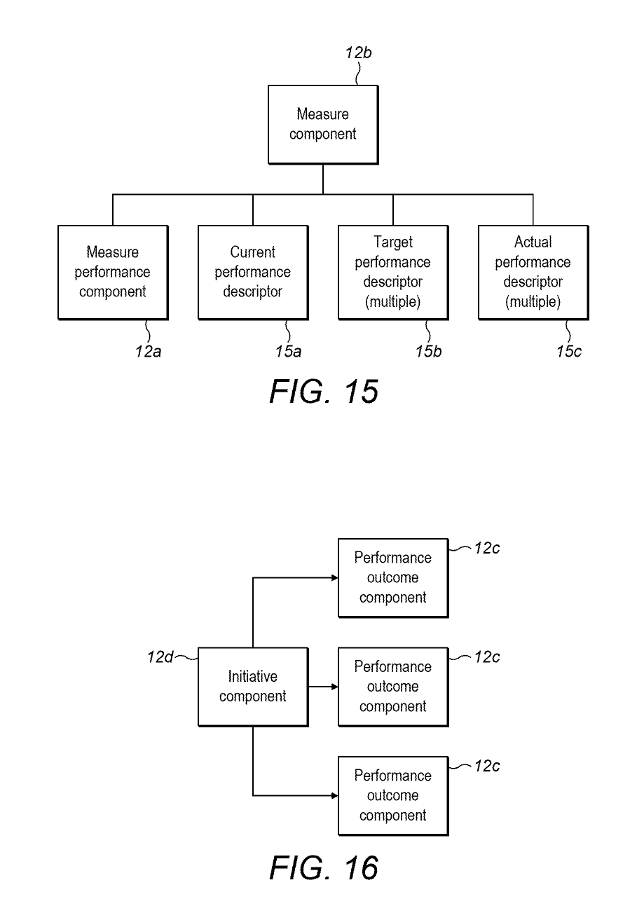

In FIG. 15, a measure component may have multiple measure descriptors (15a, b and c) to provide a description of how achievement of the performance outcome is identified.

The measure performance component 12a may provide a set of values for a measure and the level of quality expected, as shown in FIG. 14.

In one example, the measure component is ‘number of enquiries that can be processed in an hour’ and a measure component is 10 enquiries when a value of 50% has been received and 15 enquiries for the maximum 100%. If 75% of value is actually received, then the number enquiries are estimated to be 12.5. For this example a linear distribution is assumed yet any mathematical. distribution may alternatively be used.

A current performance descriptor 15a may provide the current level of achievement for the units to which the measure(s) relates. As an example, this may be 5 enquires per hour.

Multiple target performance descriptors 15b reflect the expected level of achievement for the units the measure relates to, over time. As an example, this may be an estimate of 7 enquiries after 2 months from project start, 10 after 6 months from project start and 15 after 12 months from project start.

Multiple actual performance descriptors 15c reflect the actual level of achievement for the units the measure relates to, over time. As an example, this may be an actual 8 enquiries after 2 months from project start, 11 after 6 months from project start and 14 after 12 months from project start.

FIG. 16 shows that any number of initiative components may link to a performance outcome component and that an initiative component may link to multiple performance outcome components. Initiatives may also be termed work packages, projects, programs, or any similar naming of a group of activities. One example of an initiative is ‘streamline processes’ and this may link to performance outcomes of ‘fewer process steps’ and ‘less complexity in the process’.

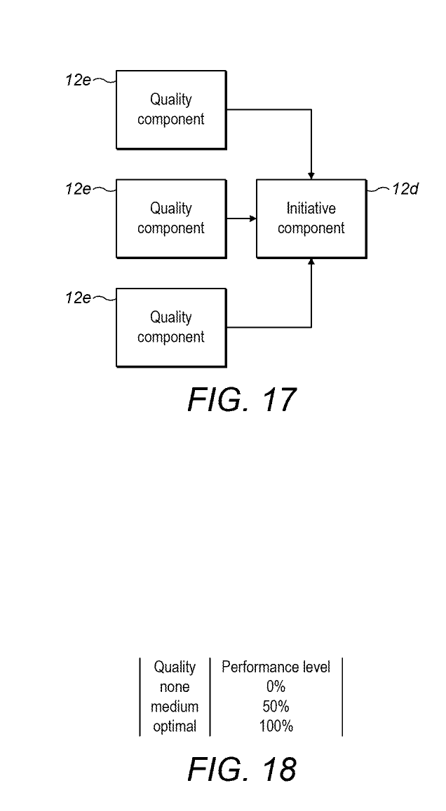

Each initiative component has one or more quality components linked to it, as shown in FIG. 17. Quality components describe the level of quality to which an initiative can be performed, for example, an initiative of ‘streamline processes’ may not be performed at all i.e. the quality level is ‘none’, to a ‘medium’ quality or to an ‘optimal’ quality.

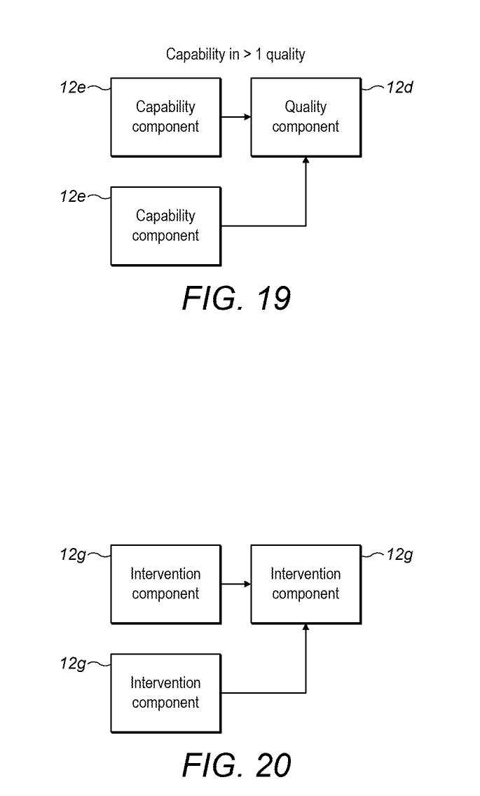

Each quality component has a minimum of one performance level, as shown in FIG. 18. An example of multiple quality components linked to an initiative is shown with a 0% performance level representing no quality being delivered and a 100% performance level representing the optimum quality being delivered.

A contribution type of logic enables logical operators and statements to be used to generate the value of the performance level on a quality component. An example is for the ‘medium’ quality of an initiative ‘streamline processes’ provides a performance level of 50% but if completed before a certain time this may increase to 55%. A further example is for the ‘medium’ quality of an initiative ‘streamline processes’ provides a performance level of 50% but if other initiatives are completed before it to certain stated levels of quality then the performance level will decrease to 35%.

Furthermore a risk component linked to an initiative component, quality component, intervention component or intervention resource component has a risk score and risk estimated value for which logical operators and statements may be used to change one or more quality performance levels. For example, a logical statement of ‘for every 5 points of this risk score then reduce the performance level of any linked quality components by 2’. A risk component may also be linked to other components to indicate to what the risk best relates. A risk may also represent an opportunity which is the chance of something happening that has a positive impact, for example, ‘for every 5 points of this risk score then increase the performance level of any linked quality components by 2’, rather than decrease the performance level by 2.

FIG. 19 shows that each quality component may have one or more capability components linked to it. When one or more levels of capability have been achieved then the initiative has been completed to the stated level of quality. For example, for the initiative ‘streamline processes’ at the medium level of quality capabilities may be ‘people trained in new processes’ and ‘systems updated with new processes available’ as capabilities.

FIG. 12 also shows that one or more intervention components 12g may be linked to a capability component 12f. An intervention component may be one of a number of intervention types with at least four intervention types as shown by 12k, l, m and n. Intervention types support the categorization of interventions into components with specific meaning to each project. A project may have one or all possible types. A project intervention type 12n represents a collection of managed activities, for example, build a new home. A process intervention type 12m represents an activity or a grouping of performed activities, for example, check the safety of the building site and establish the foundations. A material/component intervention type 12l represents one or more of a bill of materials that are used by or consumed by projects and processes, for example, a bulldozer, bricks, cable and tiles. A structure/function intervention type 12k represents an organizational function, unit, team or group, for example, a building site office.

An intervention component may be part of a network of other intervention components as shown in FIG. 20. These intervention components may have detailed supporting information that describe the characteristics of the intervention component, for example overall duration. The order of the interventions in the network may signify the ordering that they are carried out. The ordering enables structured sequencing of interventions to be described and used in the optimization and realization.

Linked to an intervention component 12h may be one or more resource components. There may be four types of further resource components linked to them as shown by 12s, 12t, 12u and 12v. These represent the detailed activities and resources needed for the intervention. The capability resource create component 12v represents the main activities for that intervention to create capability, for example, to build an area of new housing. The clear-down resource component 12u represents the closedown activities for that intervention, for example, after completion of the main capability building project to build a new area of housing then temporary capability created for the project that will include people, materials and machinery will need to be reduced. The maintain capability resource component 12t represents the resource that maintains capability for that intervention after it has been created, for example once the new area of housing has been built then maintenance processes are required to maintain the capability and value of the housing area. The ad-hoc resource component 12s represents the resources to support other resource components or add or maintain capability in their own right. For example, there may be the need for an inspection of the area by external organizations that happen at different times and for varying durations.

Furthermore a risk component 12q linked to an initiative component 12d, quality component 12e, intervention component 12g or intervention resource component 12h has a risk score and risk estimated value for which logical operators and statements may be used to change one or more resource component values. For example, this may take the form of a logical statement of ‘If the risk estimated value is greater than 500 then add the risk estimated value to total cost of resource component X’.

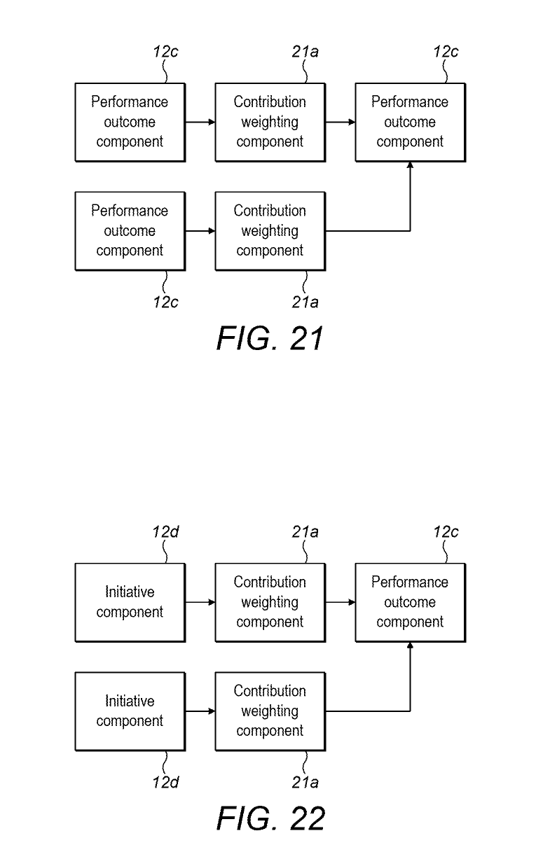

A contribution weighting 21a may be added to a link between two performance outcome components. This link represents the relative priority of the incoming performance outcome component, as shown in FIG. 21.

A contribution weighting 21a may be added to a link between an initiative component and a performance outcome component, to represent the relative priority of the incoming initiative component as shown in FIG. 22. These are significant as the Quality performance level, as shown in FIG. 18, passes through the network of initiatives and outcomes according to the contribution weightings 21a in the network. This contribution weighting may be in percentage terms where all links into each performance outcome component sum to 100% or a different relative weighting representation. When a user changes a contribution weighting on one link, the project design software 1 automatically changes the contribution weightings on the other links proportionately so that the sum remains the same.

Furthermore a risk component 12q has a risk score and risk estimated value for which logical operators and statements may be used to change one or more contribution weightings. For example, this may take the form of a logical statement of ‘for every 5 points of this risk score then reduce or cap the maximum possible performance level that can pass through outcome contribution weighting between outcome component X and outcome component Y by 5%’.

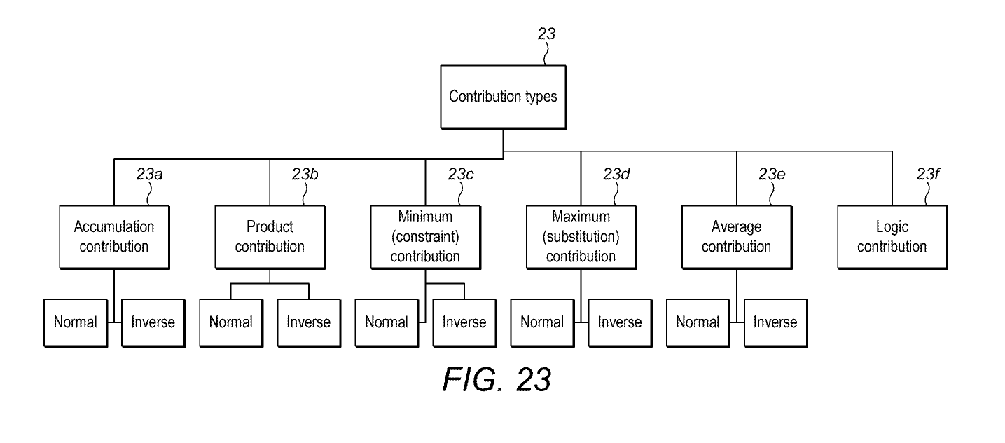

For any of the links between components represented by FIGS. 13 through to 17 and FIGS. 19 through to 22, there may be contribution types that reflect the logic of how a performance level value is calculated for a target component using the performance level values from the components linked to it. Six of the possible contribution types from 23a through to 23e are shown in FIG. 23. Each, contribution type may be normal or inverse. The logic contribution type may be a composite of many other functions, including aggregation, product, power, division, modulus, average, sigmoid, logarithmic, minimum, maximum and weighted multiplier functions.

The results of these contribution types and the performance level values may be calculated in groups or singly according to mathematical formulae.

The performance values are normalized with 0 representing the lowest possible value and 1 representing the greatest value and these are also expressed as percentages of unity (1).

The grouping of contributions allows additional logical relationships and calculations to be performed on the performance level values without the need for additional performance outcome components to be created to represent them which may increase the visual complexity of the design. Grouping of contributions may be performed for any combination and number of contribution types.

Contribution groups may be multi-leveled in that the performance value calculated for one contribution group may be an input to one or more additional contribution groups; the performance value calculated for the additional group or groups may be input into addition groups as so on. Contributions that are grouped would not have individual contribution weightings.

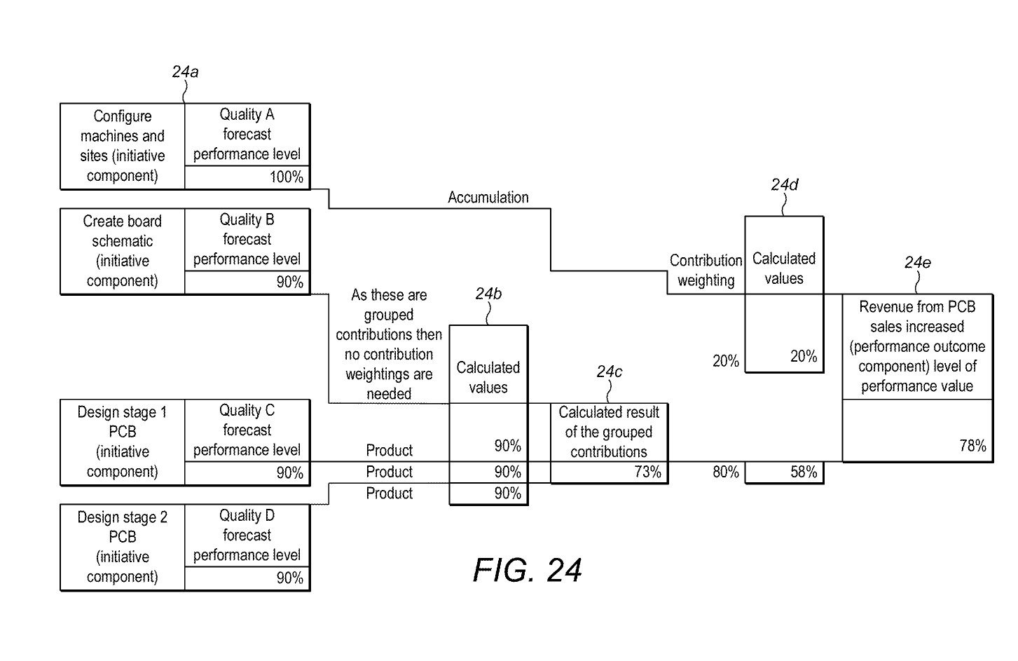

In FIG. 24 there are four initiative components 24a, each with one quality component with a forecast performance level. There is one contribution grouping 24b and one performance outcome component 24e with one performance level value calculated for each. The first initiative component ‘Configure machines and sites’ is a contribution type of accumulation, the others are grouped as a product contribution type group. The contributions from initiative components ‘Create board schematic’, ‘Design stage 1 PCB’ and ‘Design stage 2 PCB’ are all grouped together by means of a contribution grouping descriptor. As a group they have a single performance level value calculated by using a product calculation 24a and 24b.

The product of the forecast performance value of the ‘Configure machines and sites initiative’ 24a and its contribution weighting are calculated 24d are summed with the product contribution type group performance level value 24c in ‘Revenue from PCB sales increased’ 24e.

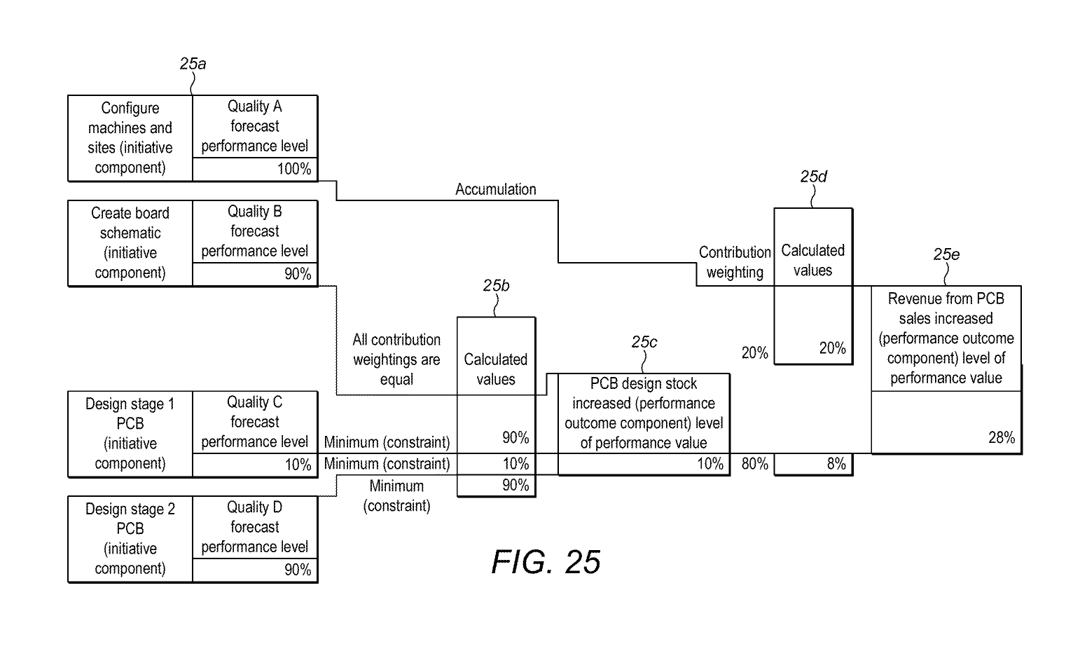

Contribution types of accumulation and also minimum (constraint) example as shown in FIG. 25 has four initiative components 25a each with one quality component with a forecast performance level. There are two performance outcome components 25c and 25e with one performance level value on each of them. The first initiative component ‘Configure machines and sites’ is a contribution type of accumulation, the others are of minimum (constraint) contribution type. The contribution weightings of the last three initiative components to the outcome component in 25c are all equal.

The product of the forecast performance value of the ‘Configure machines and sites initiative’ 25a and its contribution weighting are calculated 25d are added to the value of the ‘Revenue from PCB sales increased’ performance outcome performance level value 25e.

The performance outcome component ‘PCB design stock increased’ 25b has the forecast performance level values from the last three initiative components in as these contributions are of type normal (no additional formulae required). As the contribution type is minimum (constraint) then the minimum value of these is used 25c.

The contribution type between the first performance outcome component 25c and the second 25e is accumulation and so the product of the forecast performance value of the ‘PCB design stock increased’ 25b and its contribution weighting are calculated 25d and added to the value of the ‘Revenue from PCB sales increased’ performance outcome performance level value 25e.

Additional examples of contribution grouping are now introduced.

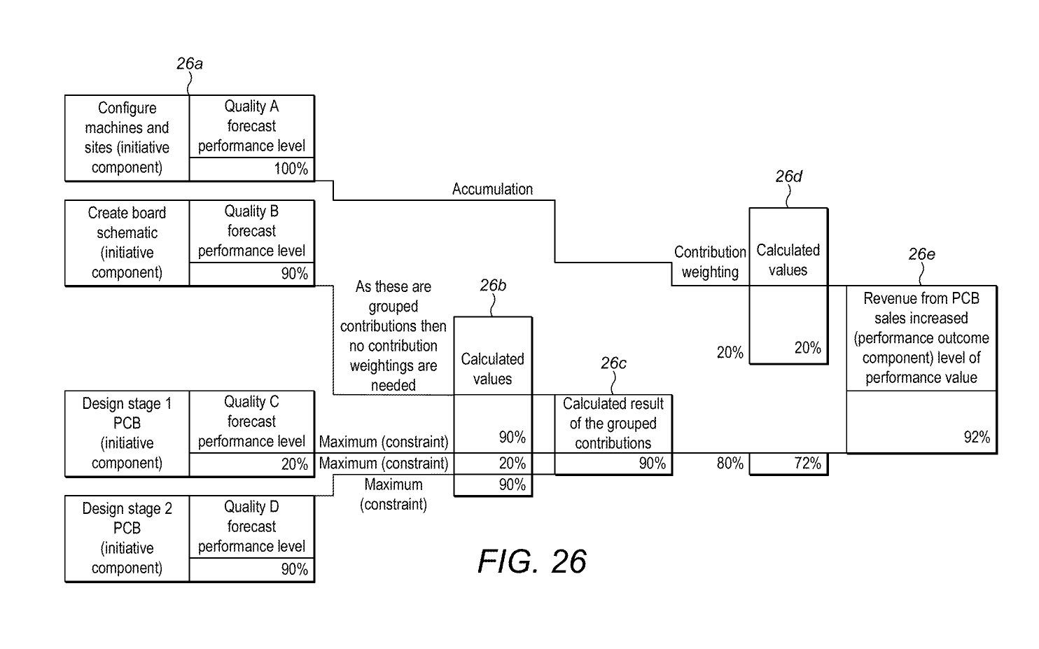

An example of accumulation and also a maximum (substitution) contribution type group is in FIG. 26. As a group they have a single performance level value calculated by using a maximum (substitution) contribution type calculation 26b and 26c. As the contribution type is maximum (substitution) then the maximum value of these is used 26c.

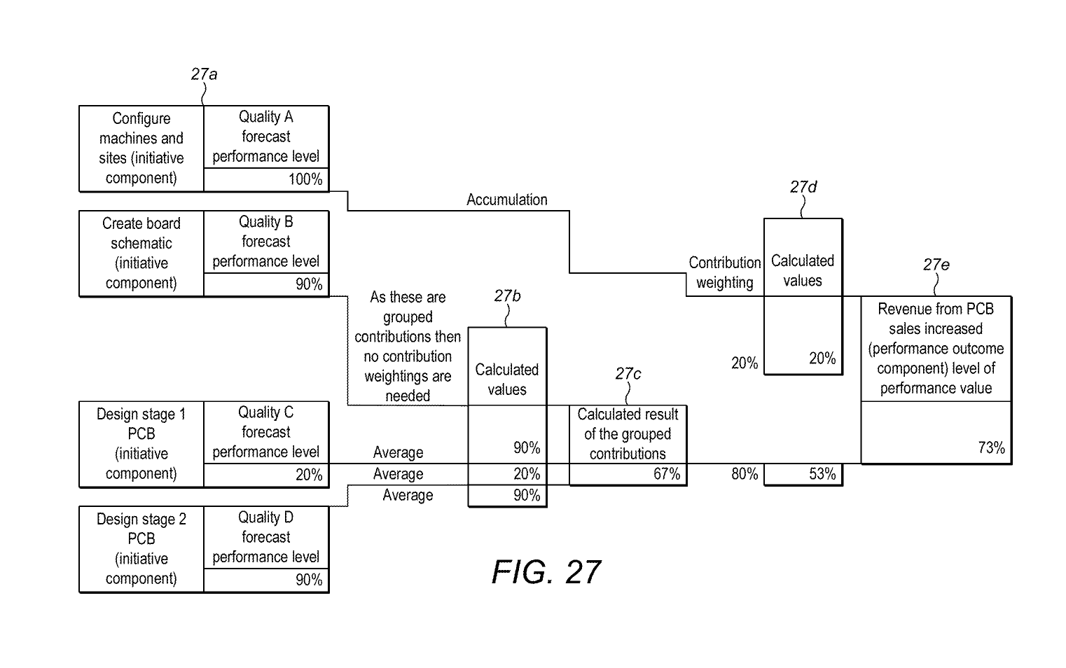

An example of accumulation and also average contribution type group is in FIG. 27. As a group they have a single performance level value calculated by using an average calculation 27b and 27c. As the contribution type is average then the average of these is used 27c.

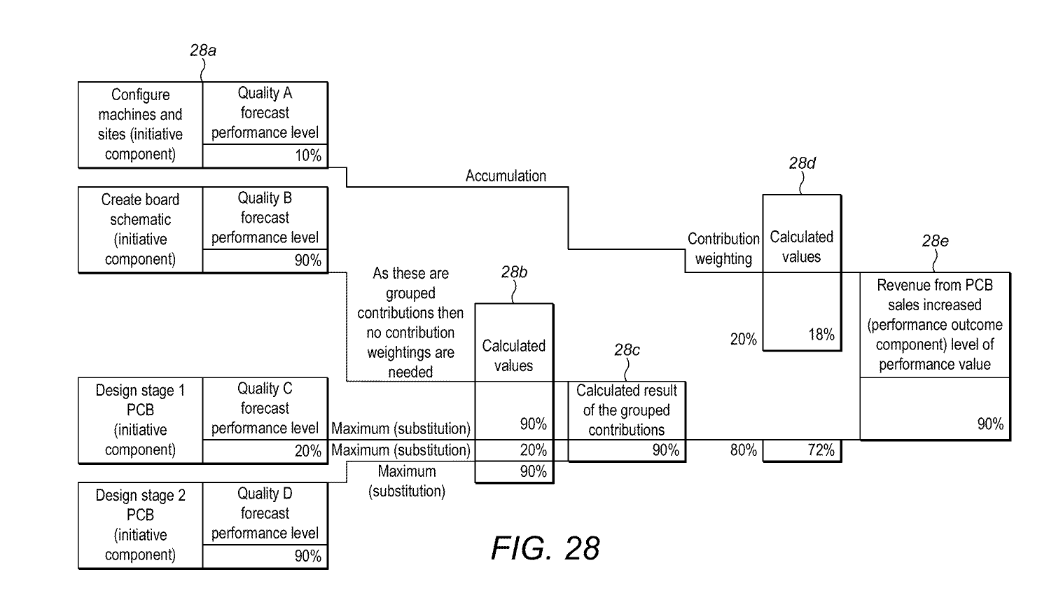

An example of inverse-accumulation and also maximum (substitution) group is in FIG. 28. As a group they have a single performance level value calculated by using a maximum (substitution) calculation 28b and 28c. As the contribution type is maximum (substitution) then the maximum value of these is used 28c. The product of the forecast performance value of the ‘Configure machines and sites initiative’ 28a and its contribution weighting are calculated 28d. As the contribution type is inverse-accumulation then the forecast performance value of the ‘Configure machines and sites initiative’ is subtracted from 100% and used 28c.

An example of contribution types of accumulation and a maximum (substitution) group with one of the group being an inverse maximum (substitution) is in FIG. 29. As a group they have a single performance level value calculated by using a maximum (substitution) calculation 29b and 29c. For the inverse-maximum (substitution) contribution type the forecast performance value of the ‘Design stage 1 PCB’ initiative component is subtracted from 100% and used 29b. As the contribution type is of the three are maximum (substitution) then the maximum value of these is used 29c.

An example of contribution types of inverse accumulation and inverse maximum (substitution) grouping is in FIG. 30. As a group they have a single performance level value calculated by using an inverse-maximum (substitution) calculation 30b and 30c. As the contribution type is inverse maximum (substitution) then the then each of the forecast performance values are individually subtracted from 100% and then the maximum value of these is used 30c.

The product of the forecast performance value of the ‘Configure machines and sites initiative’ 30a and its contribution weighting are calculated 30d. As the contribution type is inverse-accumulation then the forecast performance value of the ‘Configure machines and sites initiative’ is subtracted from 100% and used 30c.

The logic contribution type 23f shown in FIG. 23 causes the performance level value to be calculated by the application of logical operators and statements that may refer to values on any type of component or combination of components. For example, in the examples FIGS. 24 to 30 the calculated values may have additional formulae applied.

Assumption components 12r as shown on FIG. 12 may be linked to other components to represent points of view expressed about the components they are linked to or about the entire project. An assumption could be that there will be enough non-raining days in winter to continue to schedule.

Requirement components 12p represent criteria to be met by the project and they are expected to be met to some degree by the component they are linked to. A requirement component may also be linked to other requirements to represent a network of requirements. One approach to the definition of a project design is to start with the requirements and then add the other components of the design to satisfy them. This requirements led approach helps to ensure the project design does not meet any requirements or that it has components that contribute low or no value yet have a cost.

Dependency components 12o represent a dependency that one component may have on other components, projects or aspects. For example, a process to ‘Build a wall of a house’ is dependent on a process to ‘Create the foundations’. Those components, projects or aspects that a component is dependent on will have links from the dependency component to them. Moreover, as an alternative to holding a description of other components, projects or aspects then components or text descriptions may be linked to the dependency component. For example, a project to build high quality housing may be dependent on a project to research the likely demand for different types of housing in that locality. The project components representing these will be linked together using a dependency component that has a link from the research project and to the build high quality housing project.

Phases to support optimization and realization are represented by the phase component 12i. FIG. 9 is a table showing a configuration example of a phase table used in the embodiment. A quality component 12e has a performance level that may be selected to be achieved at a specific point in time. A quality component may be linked to a phase component that represents the time period during, before or after which the associated capabilities are expected to be created, maintained or disposed. Moreover, a measure component 12b may be linked to a phase component that represents the time period during, before or after which it is expected to be achieved.

### Operations of the Design Optimization and Realization System

Next the operation of the design optimization and realization system 1a will be described with reference to a flowchart.

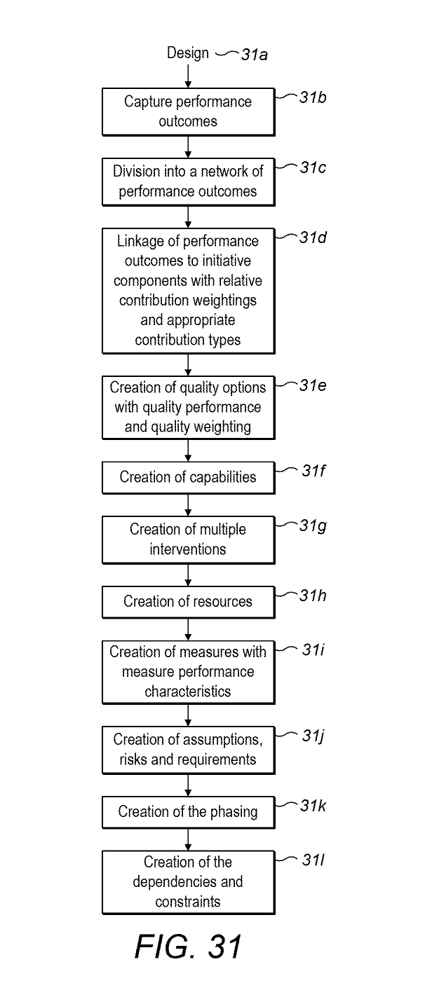

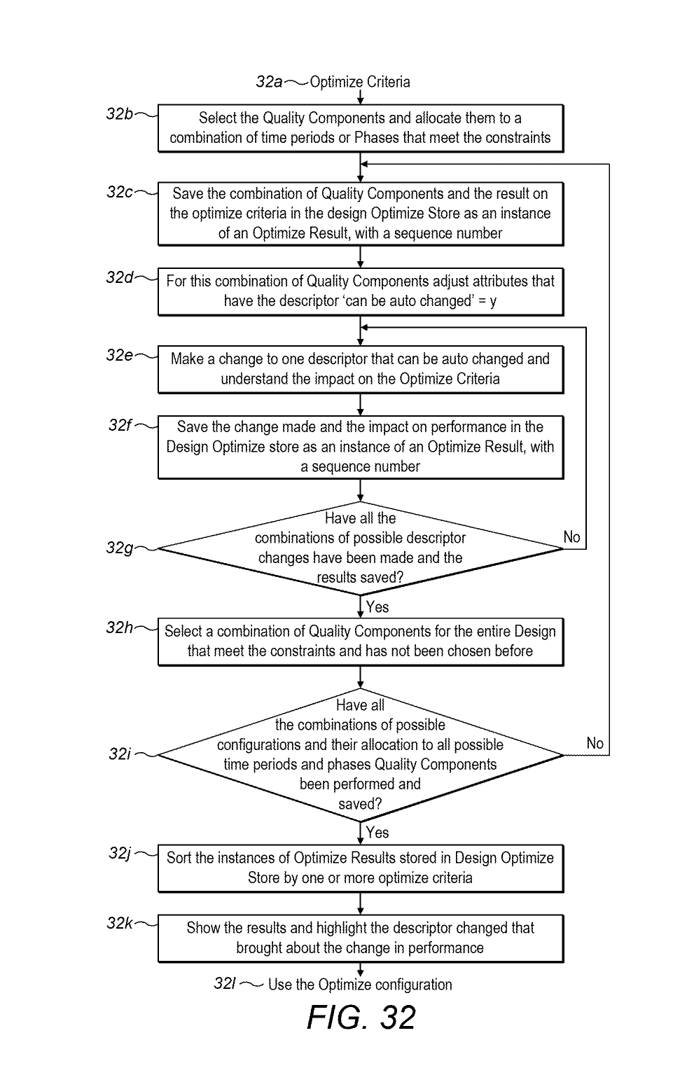

FIG. 31 is a diagram schematically showing the flow of processes for the definition unit 1b. FIGS. 32 through to 33 are diagrams schematically showing the flow of processes for the optimization unit 1c. FIG. 34 is a diagram schematically showing the flow of processes for the realization unit 1d.

FIG. 31 is one embodiment of the processes for the definition unit 1b. The definition unit 1b processes may be carried out in different order as data becomes available and different people who are able to contribute are available. The processes may be carried out multiple times as further information becomes available and increased clarity on the project design develops.

In implementing the method of FIG. 31, certain data is stored at certain times. Phases for each design are stored in the phase template storage 1e. The main design storage of components and relationships, as permitted by the structure information storage 1h, is in the detailed component information storage 1f. Versions of the project design and one or more instances of optimize values may be stored in the design model compare storage 1g. These may then be compared to understand differences and the impact on descriptors of the differences. The structure information storage 1h stores therein a structure model which is information on the component and relationship structure for the project to be developed and managed. The design optimize store 1i has multiple instances of component and descriptor values generated by the optimization unit. The optimization unit 1c uses this store to support the project manager and delegates to optimize the project design.

The project is designed at step 31a by one or more users.

At step 31b of FIG. 31, the definition unit 1b captures the performance outcomes 12c identified by the sponsors of the project and their representatives. At step 31c, each performance outcome has descriptors and links added to form a logical network, as shown in FIG. 4.

Each performance outcome may have multiple initiatives that are candidates for contribution as shown in FIG. 4. At step 31d, these are captured and added to the network. Contribution weightings are added and the relevant contribution types and descriptors are stored.

Initiatives have a ‘forecast time’ descriptor that represents the time period within which the initiative is expected to take place and complete. A ‘forecast cost’ descriptor represents the cost that the initiative is expected to incur. A ‘forecast performance leve’ descriptor represents the amount of benefit that the initiative is expected to realize.

The quality components 12e, representing the different options for each level of quality that are decided to be appropriate are captured at step 31e. The multiple quality components linked to each initiative have different levels of what is done, how it is done, where it is done, when it is done and who does it. Each intervention option has implications for time, cost and quality. One option may be to ‘do nothing’ if the intervention is not mandatory for the overall project.

Each quality has a ‘forecast performance level’ descriptor that represents the amount of benefit that the option is expected to realize, also an ‘actual performance leve’ descriptor that represents the amount of benefit that the option is actually realizing.

Each quality may have a number of capabilities 12f that are changed over time and contribute to the performance level for a quality, and are created at step 31f. These are captured and added to the network.

Capabilities have a ‘forecast time’ descriptor that represents the time that the capability is expected to complete. A ‘forecast cost’ descriptor represents the cost that the capability is expected to incur. A ‘forecast quality’ descriptor represents the amount of benefit that the capability is expected to realize.

Each capability component may have multiple intervention components 12g needed to achieve it and these are agreed with the project contributors and their representatives. These are also added to the network for the project at step 31g. Each intervention component has a set of descriptors that include: ‘Forecast time’ descriptor represents the start time and duration in which completion is expected, ‘Forecast cost’ descriptor represents the cost expected to be incurred, And ‘Forecast quality’ descriptor represents the amount of benefit expected to be realized.

As with previous descriptors and storage these are identified and collected by users working on or associated with the project.

Each intervention component may have multiple intervention resource components 12h needed to achieve it, and these are agreed with the project contributors and their representatives. These are also added to the network for the project at step 31h. Each intervention resource component can be of different types including ‘people’, ‘components’ or ‘other’. For the people type resources the forecast roles, quantities, cost rates, time periods and utilization rates may be stored. For component type resources the item, quantities, cost rates and times periods may be stored. For other type resources, the item, quantities, cost rates and times periods may be stored.

For all the resource types, the usage of resource can be tied to specific stated time periods (ad-hoc resource type) or can be linked to the phases.

When linked to a phase, for the capability create resource type, if the phase times or another resource types start time changes then the start and end times change accordingly.

Furthermore, the resource may be used for a set duration and be linked to the end of a phase, either to finish when the phase ends or when another resource type ends (clear-down resource type). For the dear-down resource type if the phase times or another resource type end time changes then the start and end times change accordingly.

Additionally, by linking them to the phases they may be linked to the start and end dates of a given phase or phases (maintain capability resource type). For the maintain capability resource type, if the duration of the phase changes then the duration that the resource is required for also changes to match the updated start and end date of the phase.

Each performance outcome component may have multiple measure components 12b to measure the performance and these are agreed with the project contributors and their representatives. These are also stored on the network for the project. A measure component may have one or more measure components to enable levels of expected or actual levels of achievement of the measure to be represented. Measures with measure performance characteristics are created at step 31i.

Each measure component has a set of descriptors that may be populated with: a measure component, a current performance descriptor, and/or multiple target performance descriptors.

A measure component that is financial has a descriptor of ‘financial?’ set to y. For each target performance descriptor, a number of units descriptor with associated performance level descriptor are stored. One number of units value stored will represent the current performance level of the measure, also termed in the state of the art a baseline value. This represents the current value of the measure component. The current performance level linked to this is 0% as this is the number of units being measured when no additional value is being created by the project for this performance outcome.

One number of units value stored represents the maximum expected performance level of the measure. This represents the maximum forecast value of the measure component. The current performance level linked to this is 100% as this is the number of units being measured when the maximum possible value is being created by the project for this performance outcome.

There may be additional values for the number of units that represent forecast levels of performance between 0% and 100%.

Stored and linked to components may be assumption 12r, risk 12q and requirement 12p components that are created at step 31j.

Phases 12i are defined and stored 31k in the phase template storage 1e. The project manager may have many phases defined, each with start and end time descriptors. Quality components may be then linked to one or more phase components to represent when the performance level stored on the quality component is expected to be achieved.

Dependency components 12o may be added to provide an additional. level of dependency logic to the design 31l. A dependency ancestor descriptor stored represents the components other components are dependent on. A dependency descendents descriptor represents those components dependent on the components stored in the dependency ancestor descriptor.

Constraints may be added to any component or to descriptors on the components and that supports the optimization unit 1c calculations. Any of these constraints may have logical statements and programming constructs that may reference one or more descriptors from within the design on any component. They include:

Set ‘must perform’ with logical statements and programming constructs that may reference one or more attributes from within the design on any Component. For example, this quality component ‘D’ must be performed in the same phase as quality component as ‘E’.

Set ‘must not perform’ with logical statements and programming constructs that may reference one or more attributes from within the design on any Component. For example, this quality component ‘D’ must not be performed in the same phase as quality component as ‘E’.

Examples of logical constructs include:

Set ‘must perform in phase’ (or date range)

Set ‘must not perform in phase’ (or date range)

Set ‘must perform with’ (other component(s))

Set ‘must not perform with’ (other component(s))

Set ‘must perform before’ (phase or date or component(s))

Set ‘must not perform before’ (phase or date or component(s))

Set ‘must perform after’ (phase or date or component(s))

Set ‘must not perform after’ (phase or date or component(s)) •

In addition, an ‘else’ statement may be used as part of the logical constructs for a change to be made. For example, it may be defined that the quality component ‘D’ must be performed in the same phase as quality component as ‘E’ eke the performance level of outcome A is reduced by 10%.

FIG. 32 is a flowchart illustrating operation according to one embodiment of the processes for the optimization unit 1c. The processes may be carried out multiple times as further information becomes available and as clarity on the design develops. Other optimization algorithms include gradient based analyses or genetic algorithms.

At step 32a, the project manager or nominated person, through the GUI, selects measure components 12b to optimize (one or more) by setting an ‘optimize measure?’ descriptor on the component to ‘y’ and a priority descriptor to a numerical value that represents the order of priority given to the optimization process. Also the descriptor ‘optimize for date’ can be set for a specific date or a range of dates to optimize for.

Then, at step 32b, the optimize unit select a combination of quality components and a combination of phases for the entire design that meet the constraints. If quality components and a combination of phases have already been chosen, these will be the starting configuration. Performance levels and cost descriptors are generated throughout the model, using the selected phase and quality component descriptors.

At step 32c, design optimize criteria may be stored in the design optimize store as an instance of an optimize result, with a sequence number. Constraints may also be added or updated to any component and that will support the optimization unit 1c calculations.

At step 32d, each component of the project design has on creation a descriptor of ‘can be auto changed?’ The optimize unit will take the current combination of quality components and will adjust the descriptors of those components that are connected into them as part of the design network and that have their descriptor ‘can be auto changed’ set to ‘yes’.

At step 32e, a change of numerical unit higher or lower is made to one descriptor on a phase date, an intervention component or the components linked to it so the impact on the Optimize Criteria can be compared. These changes may also be to remove, decrease or increase constraints, risks or dependencies. Additionally, for descriptors that are for categories then the value may be changed to a new category.

At step 32f, the configuration of quality components is saved in the design optimize store as an instance of an optimize result with the value of the descriptor changed for this step in the process, the descriptor value for performance level on the measure components that are being optimized, the net positive or negative impact on each of the descriptors and a sequence number.

At step 32g, it is determined whether all the combinations of possible descriptor changes have been made for the chosen combination of quality and phase components and the results have been saved. Steps 32e and 32f are repeated until a positive determination is made. Then, at step 32h, a combination of quality components and a phase for the entire design is selected that meet the constraints and have not been chosen before. At step 32i it is determined whether all the combinations of possible configurations of them and their allocation to all possible phases and quality components has been performed and saved in the design optimize storage. Steps 32c to 32h are repeated until a positive determination is provided by step 32i.

The design optimize store has multiple instances of component and descriptor values that are compared by the optimization unit 1c. At step 32j, the instances of optimize results stored in the design optimize store are sorted in order of the size of performance difference of the value for performance level value on the measure components that are being optimized. At step 32k, the results are shown in order of the closeness of the value for performance level on the measure components that are being optimized as specified in the optimize criteria. Also at this step, the descriptor that has been changed between each instance of the sorted results is highlighted.

This enables users (e.g. the project manager or their representative) to understand options and their impacts for progressing with a project design that is optimized around priority performance outcomes and measures. As a result of the features of FIG. 32, data relating to the automatic optimization of project designs in their planned ability to meet priority outcomes is made available to users.

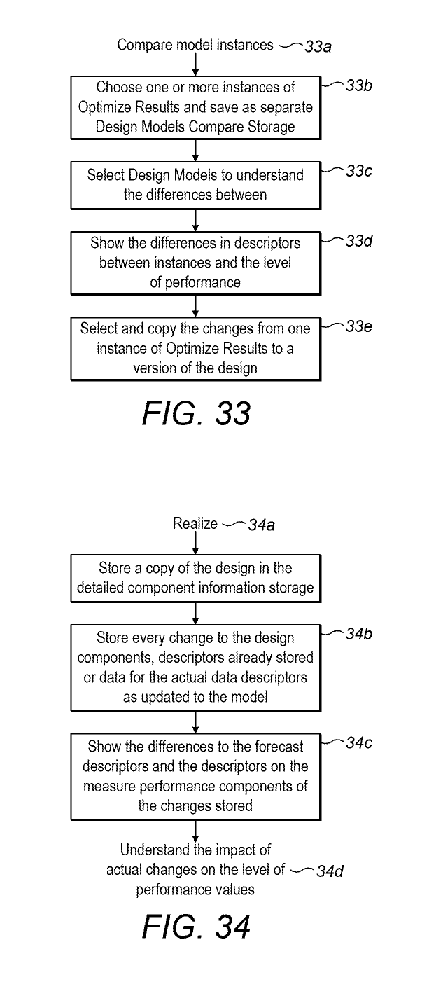

FIG. 33 is a flowchart illustrating operation of the project design software 1 according one embodiment. FIG. 33 relates to the processes for the comparison of designs in the optimization unit 1c. Comparing model instances provides insights into the differences between them and the impact on performance outcomes of those differences 33a.

At step 33b, one or more instances of optimize results are chosen and stored in the design models compare storage 1g. At step 33c, design models to compare are selected from the design models compare storage. At step 33d, the differences in descriptors, including the differences between the performance level value are shown on the measure components. At step 33e, the preferred design model from the design models compare storage is selected and values copied to a version of the design for usage and store in the detailed component information storage.

FIG. 34 is a flowchart illustrating operation of the project design software 1 according one embodiment. FIG. 34 related to processes performed by the realization unit 1d 130. The processes may be carried out multiple times as further information on actual performance becomes available. Delivery of the project results in changes being made to the project design and an understanding of the implications of changes made on performance outcomes is required.

The realization process starts at step 34a by storing a copy of the design in the detailed component information storage 1f. At step 34b, every change to the design components, descriptors already stored or data for the actual data descriptors are stored as updates to the model. Actual values include resource component descriptors that include: ‘Actual time’ descriptor that represents the actual start time and duration expected in which to complete, ‘Actual cost’ descriptor represents the cost actually incurred, and ‘Actual quality’ descriptor represents the amount of benefits actually realized.

At step 34c, the differences to the forecast descriptors and the descriptors on the measure components of the changes stored are shown. The impact of actual performance on the actual performance outcomes is automatically presented at step 34d.

Next, a specific example of a process for the design optimization and realization system will be described on the basis of a specific example of a target project.

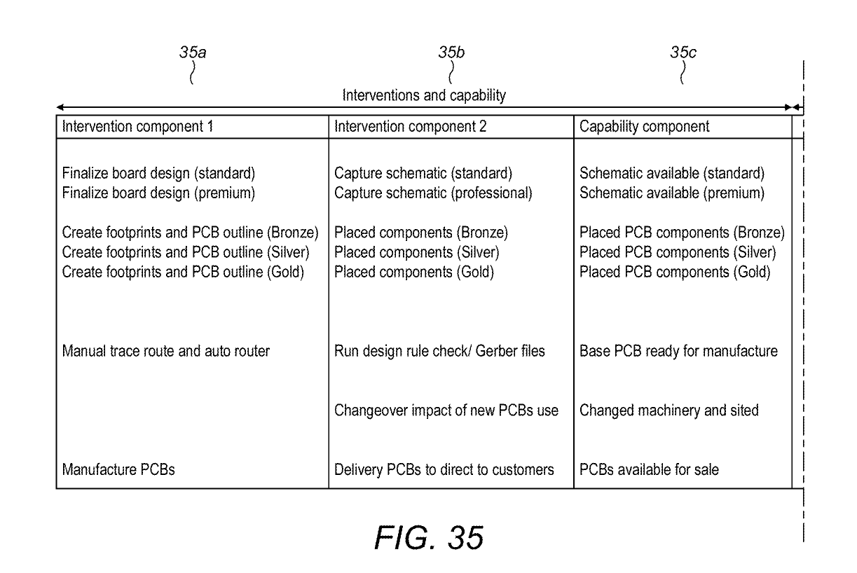

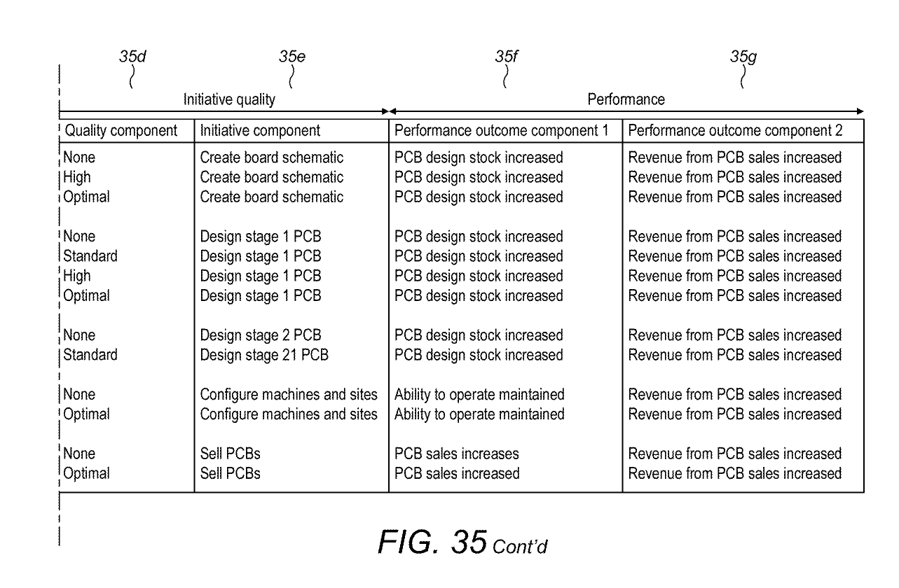

FIG. 35 is a table showing a configuration example of a target project. This serves as an example to illustrate how a user interacts with the project design software 1 to define a project, and how the software 1 responds. This example uses many, but not all, of the components etc. that are described above.

The target project shown in FIG. 35 is a Printed Circuit Board (PCB) example which needs a schematic produced, two stages of design, the set up of the manufacturing capability and the manufacturing and sales activities.

The schematic of the target project requires the board design to be finalized and the schematic to be captured. If carried out, it can be completed to one of two quality levels, high or optimal. For the first stage of the design, if completed, the footprints and a PCB outline need to be created and the components placed. These interventions relating to the first stage of the design can be completed to either a standard, high or optimal quality level.

The second stage of the design, if carried out, can be performed to one level of quality, which is standard quality. The activities for this are a manual trace route, auto router and then the design rule check and Gerber™ files. The set up of the manufacturing capability, if performed, can only be performed to an optimal level of quality. Likewise the selling of the PCBs, if carried out, can only be performed to an optimal level of quality. This includes the manufacture of the PCBs and the delivery of them directly to customers.

To allow the user to enter the data, in FIG. 35 the user of the software is presented through the GUI with a blank canvas with a choice of a library of component types. The appropriate component types are selected by the user and an instance of them moved to the canvas before a name is entered for each.

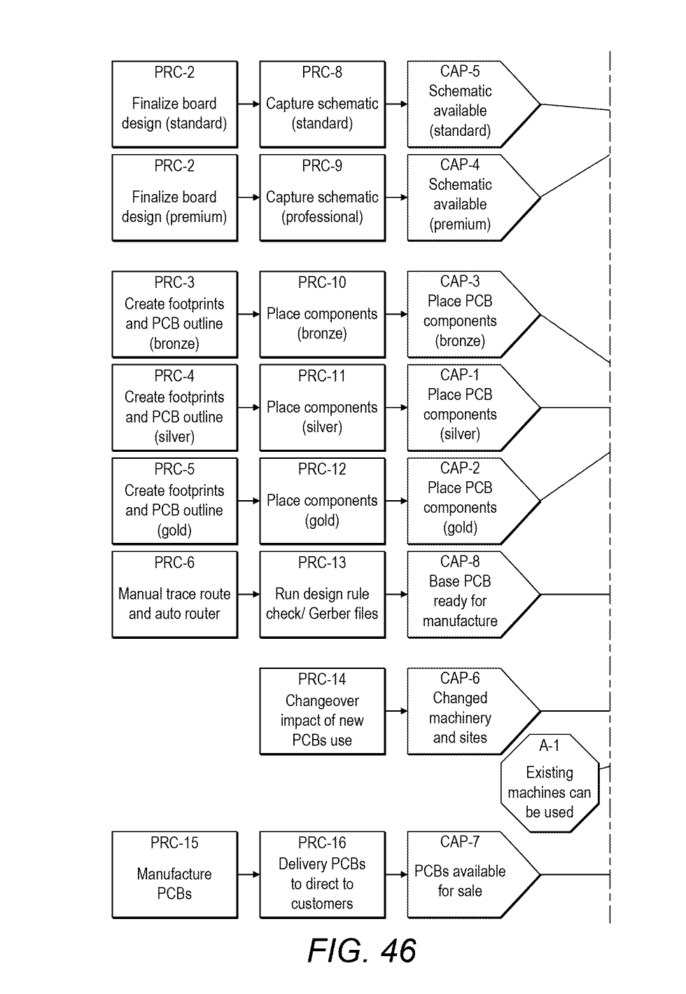

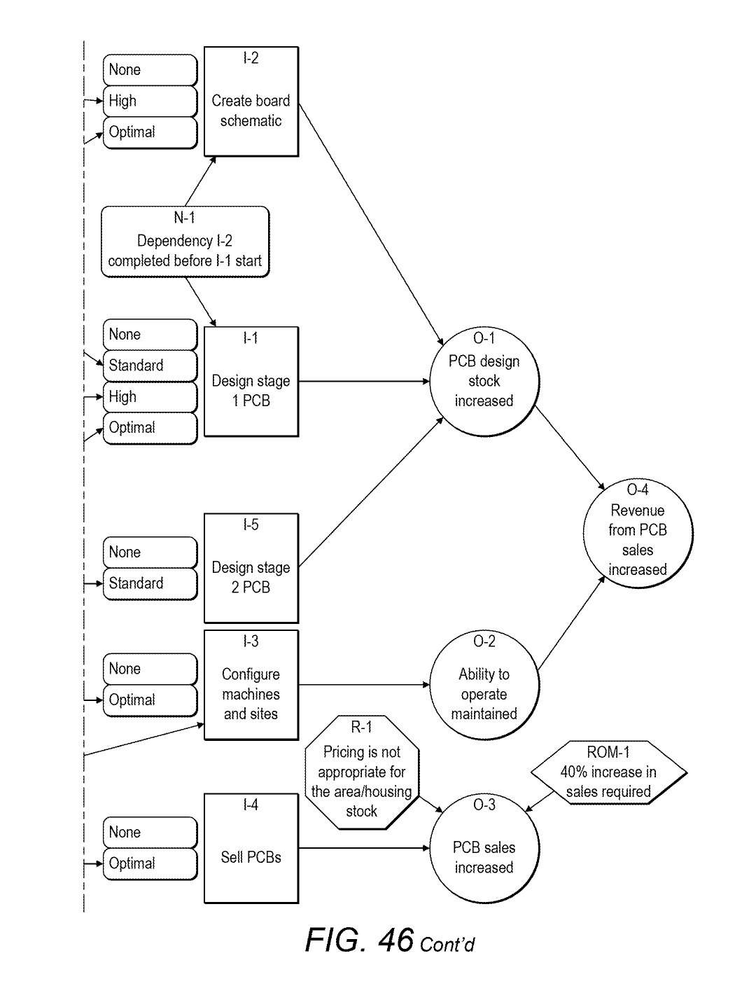

An example of component instances presented through the GUI is shown in FIG. 46. Those component instances with a reference starting with PRC are process intervention type 12m. They could have been represented as project intervention 12n, material/component intervention 12l or structure/function intervention 12k types but in this example the intervention components 12g are best suited to process intervention types 12m.

Those component instances with a reference starting CAP are capability components 12f, which are changed as a result of the intervention components 12g. These changes in capability provide a level of quality to be delivered as part of an initiative. The instances of quality components 12e are the rectangles linked to the instances of initiative components 12d, as shown in FIG. 17.

The level of quality an initiative delivers contributes to the achievement of outcomes. Those component instances with a reference of O are performance outcome components 12c.

Also shown in FIG. 46 is an instance of an assumption component 12r, linked to I-3. An instance of a risk component 12q is shown linked to O-3. For requirement components 12q an instance is shown linked to O-3. A dependency component 12o is also shown linking I-1 and I-2.

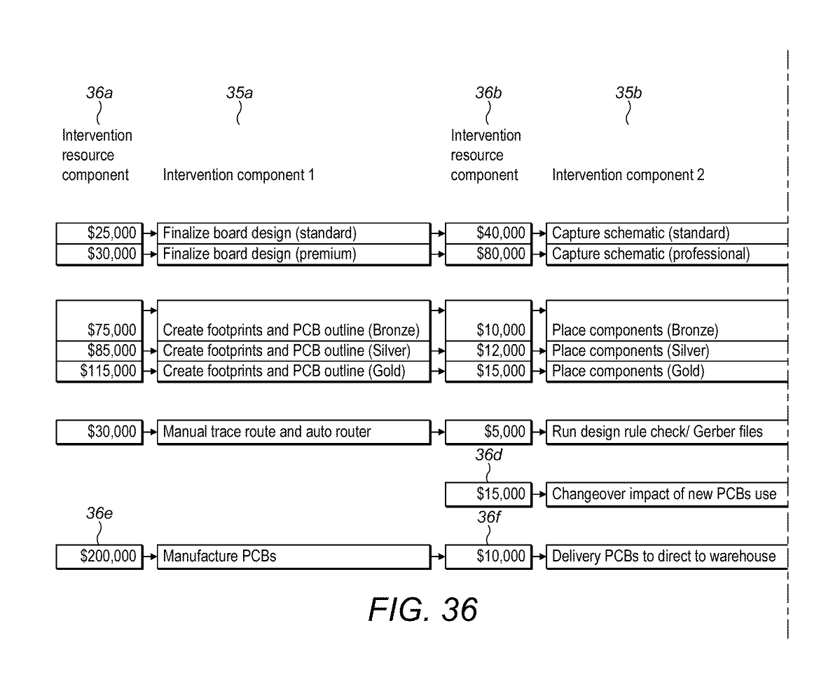

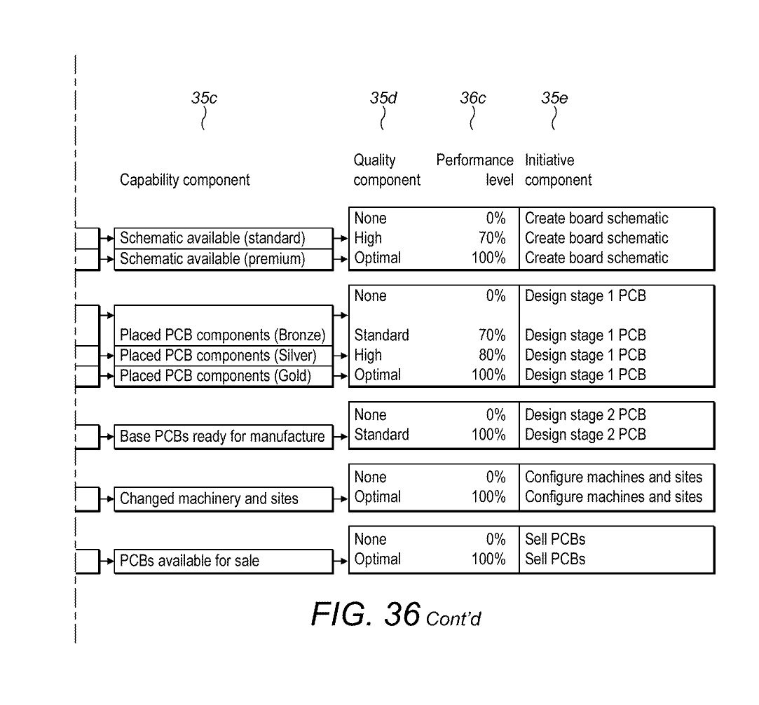

The contributions between the resource, intervention, capability, quality and initiative components are shown in FIG. 36. Through the GUI, the user is able to link the instances of the components by selecting one instance and then selecting the target instance. Instances of intervention components 12g may be linked to one another to show the expected flow of their enactment, as shown in FIG. 20.

Although not shown in FIG. 46, the intervention components 12g may link to more than one instance of the capability component 12f. For example, there may be a common process that contributes to the capability component 12f instance of ‘Placed PCB Components’ (Bronze, Silver or Gold). Rather than create three instances with the same names and resources, then they can be created once and linked to all three of the capability component 12f instances.

Also not shown in FIG. 46 is that a capability component 12f instance may be linked to more than one instance of quality component 12e. For example, there may be a common capability ‘Guidance for Design stage 2 ready’ that contributes to the Standard High and Optimal instances of quality components 12e for Design stage 1 of the PCB I-1. Rather than create three instances with the same names, then they can be created once and linked to all three of the quality component 12e instances.

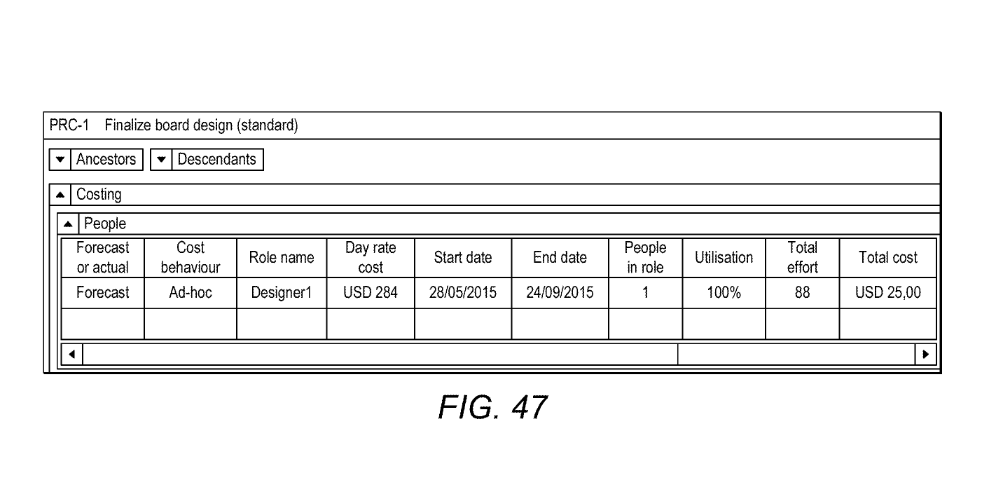

The cost of an iteration of each intervention is shown in 36a and 36b. Through the GUI the user is able to select a component instance and select an option to Edit Data. One set of data available to edit for an instance of intervention component 12g is the intervention resource component 12h. In FIG. 47 an ad-hoc resource component 12s is shown for the ‘Finalize board design (standard)’ intervention component instance 12g. If a different cost behavior was required then the other types of intervention resource component 12h could have been used, for example 12t, 12u or 12v.

The names of the levels of quality and the associated performance level for each quality component 12e are shown in FIG. 36. The performance levels 36c can be entered using the GUI by the user selecting a quality component 12e selecting the option to Edit Data.

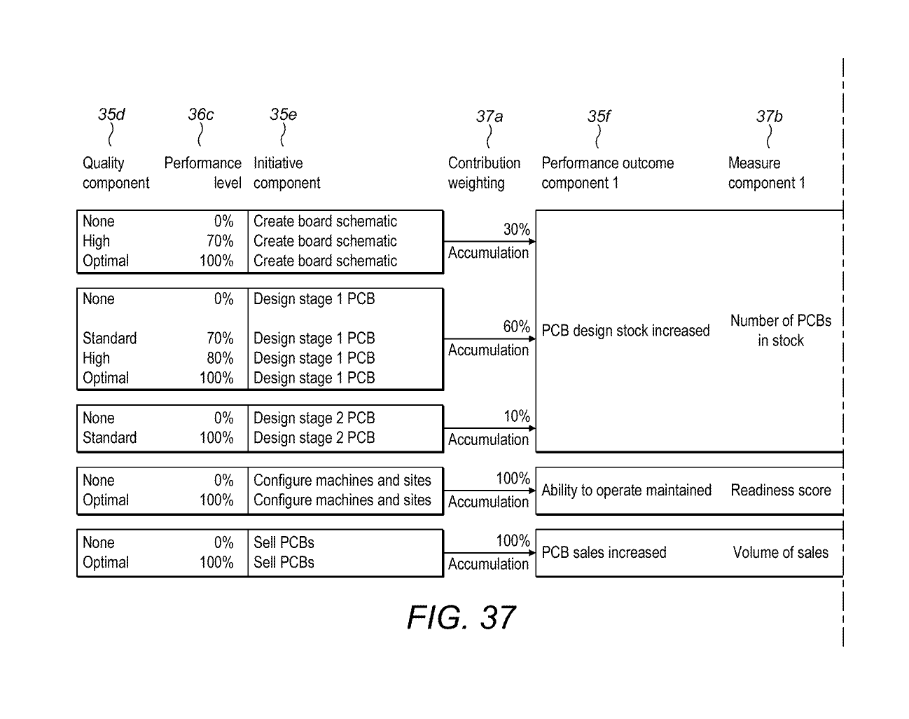

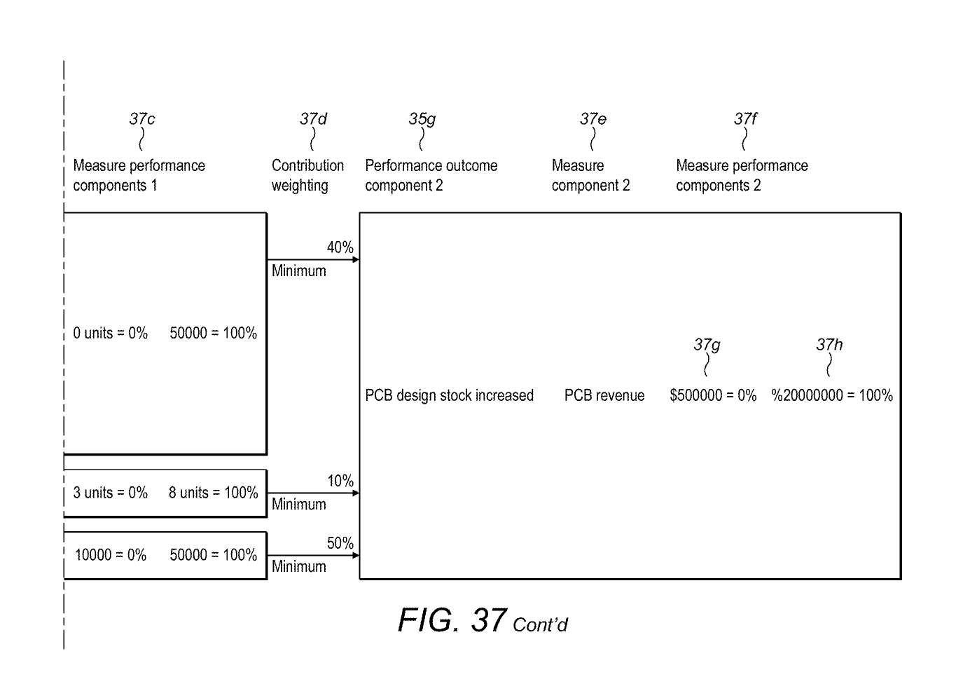

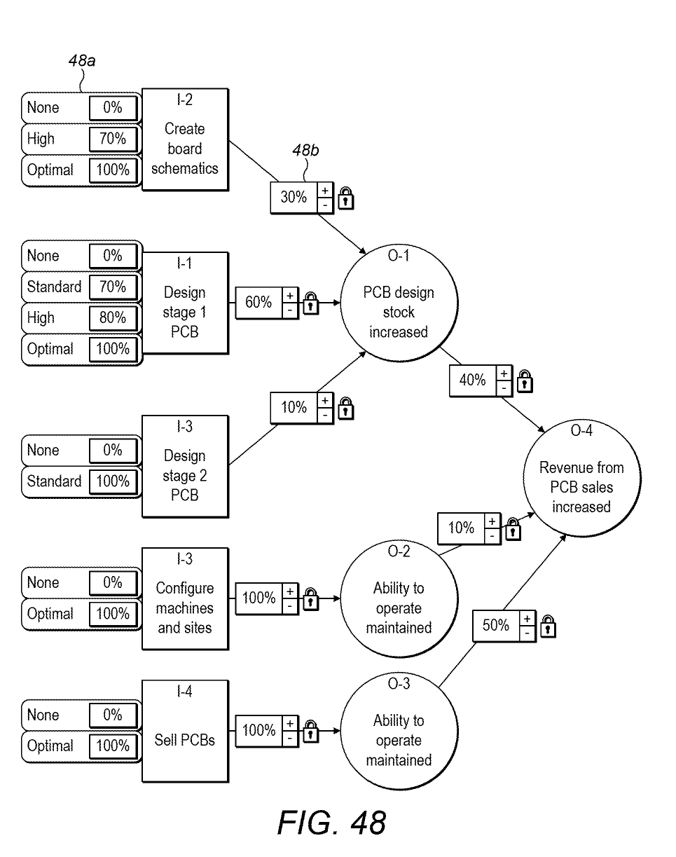

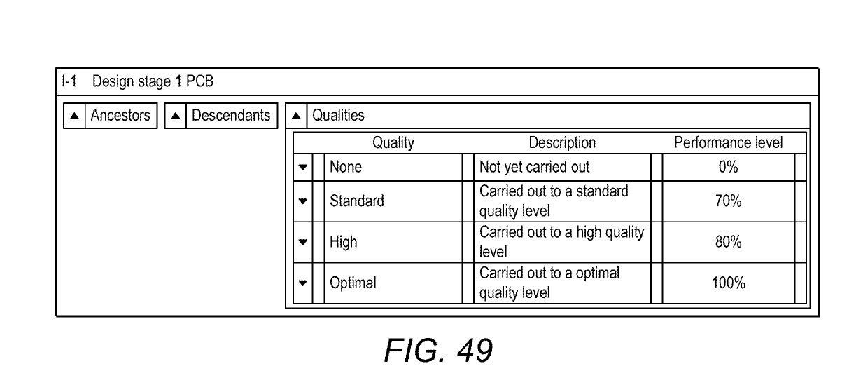

In FIG. 37, the accumulation contribution 23a types are shown in 37a and 37d between the initiative and performance outcome components. As an example, the ‘revenue from PCB sales increased’ 35g will be contributed to by the ‘PCB design stock levels increased’ 35f, the ‘Ability to operate maintained’ 35f and the ‘PCB sales increased’ 35f. This information has been represented through the GUI by selecting an option to see the contribution weighting percentages 37a and quality performance levels 36c. The user may then edit the values displayed for the contribution weighting percentages 37a. As shown in FIG. 48, by clicking on a quality component instance 48a and choosing ‘Edit Data’ enables the performance levels to be changed. The table with this information is shown in FIG. 49.

The quality component performance levels and the contribution weighting contribution percentages presented through the GUI are shown in FIG. 48.

The type of contribution can be changed through the GUI by clicking on a link and selecting a different type, the line changes color to signify each contribution type.

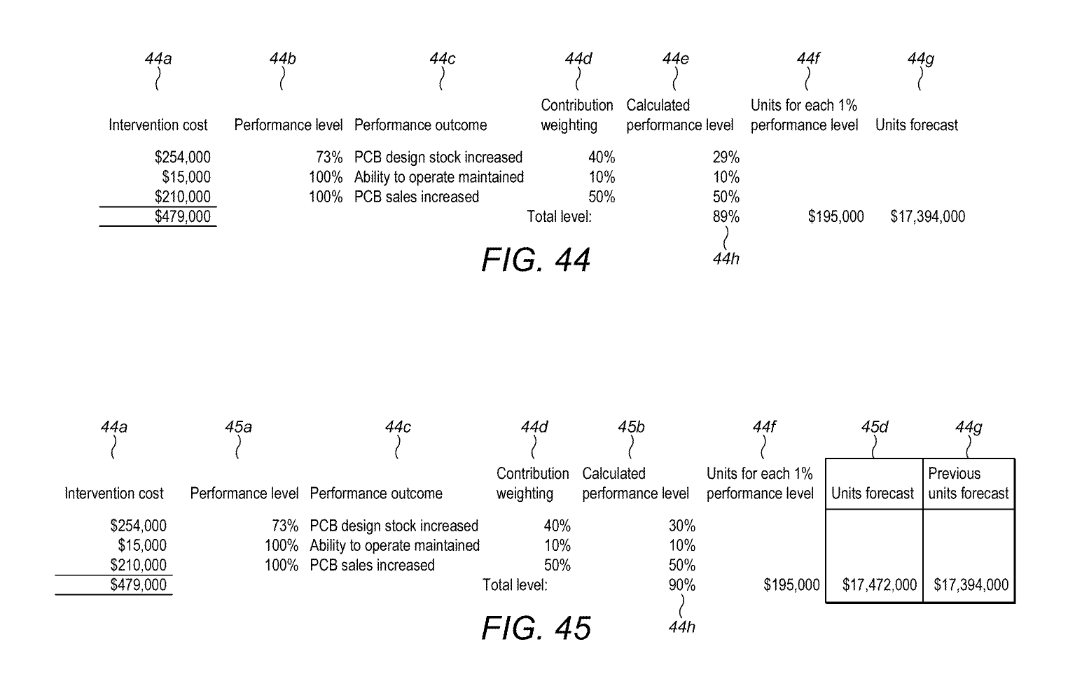

Also shown in FIG. 37 is information on the measure components 37b and 37e and measure performance components 37c and 37f. The forecast revenue 44g for ‘Revenue from PCB sales increased’ 35g is shown in FIG. 44.

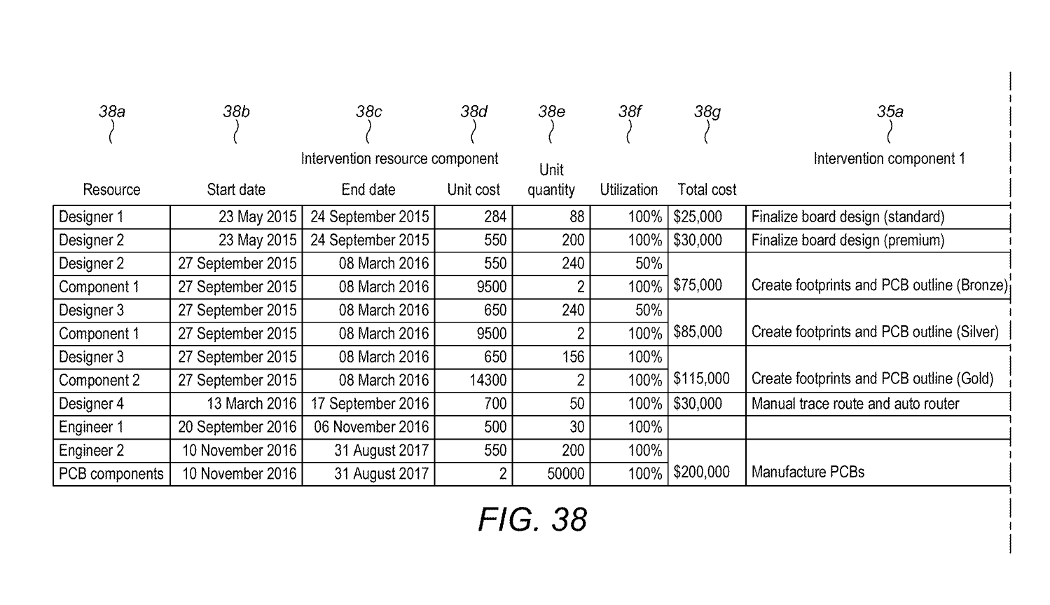

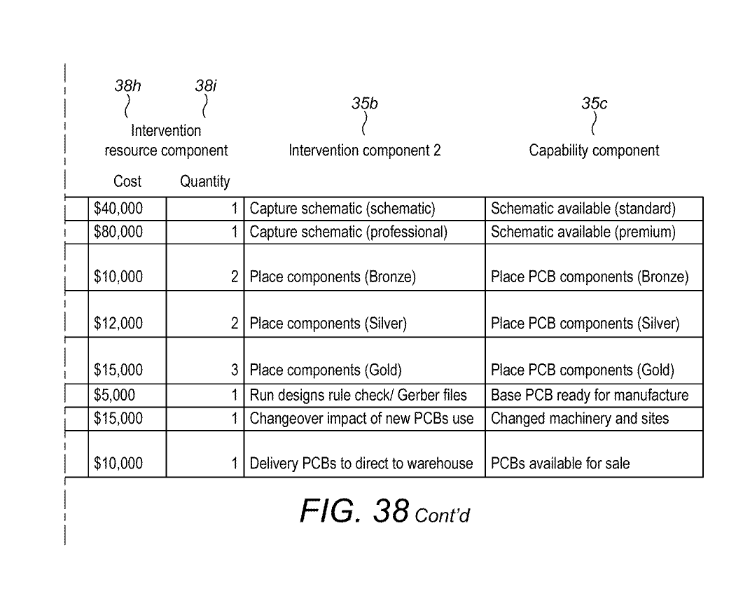

In FIG. 38, the resource cost information is shown for the intervention components 1 35 and 35b and stored on the intervention resource components 12h. This information is 38b, 38c, 38d, 38e and 38f which are entered through the GUI by selecting Edit Data after clicking on an intervention component 12g. The entry screen for the ‘Designer1’ resource 38a is shown in FIG. 48.

With this information the costs of each intervention 38h can be calculated. Resource cost information for intervention component 2 35b is shown in summary.

A descriptor can be set on each instance of a component to signify if the values can be auto-changed by the optimization unit 1c during design optimization.

The components available to the software application are defined from the structure information storage 1h. When the components and descriptors are entered through the GUI or loaded into the software application then into they are stored in the detailed component information storage 1f.

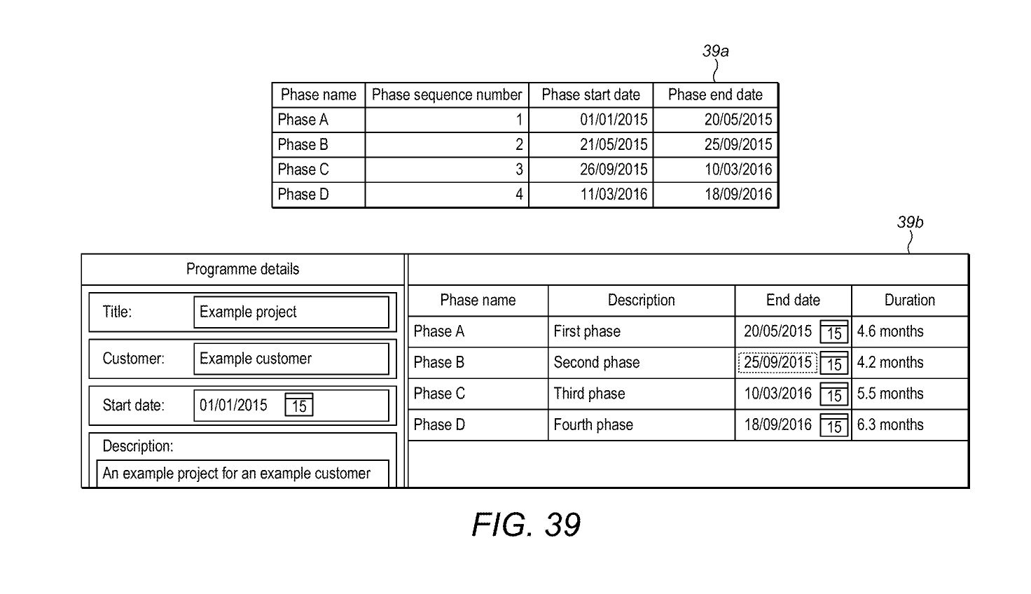

In FIG. 39, example instances of Phase components 12i and dates are shown 39a that are captured by the definition unit 1b into the phase template storage 1e. Through the GUI the entry of the data is made into a table as shown by 39b.

Next, a specific procedure for generating an optimized design for the above-described project for a Printed Circuit Board will be described.

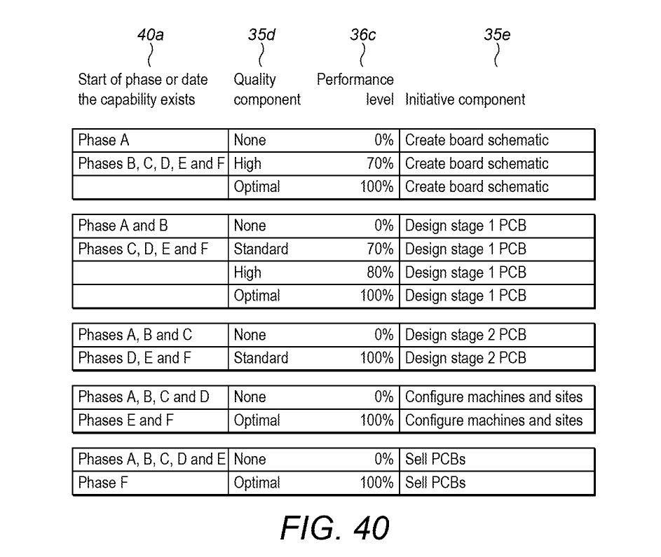

First, the optimization unit 1c reads the phase template storage 1e and the detailed component information storage 1f. The optimize criteria is set to the generation of initial performance descriptors. The phases shown in FIG. 39 are used in FIGS. 40 and 40a to show when different, and therefore capability, are estimated to be available. For example, for ‘Design stage 2 PCB’ 35e there will be 0% capability 36c for this in phases A, B and C 40a yet this will change to 100% capability 36c in phases D, E and F 40a. An example of the GUI to achieve this is shown in FIG. 10.

The grid 10a has instances of phase components 40a along the x axis and the instances of initiative components 40d along the y axis. In the grid are the instances of quality components 40d that can be selected to define the phasing of the delivery of capabilities as part of the project.

The capabilities when delivered will result in the performance levels 40c being passed into the performance outcome components 12c, measure components 12b and measure performance components 12a. An example of this is shown in FIGS. 10 and 10b. The effect of the choices 10a as the performance levels 10c is passed to the performance outcome components and then onto the measure performance components 10d is shown in 10b.

The resource and cost information for each intervention component 12g is available as shown in FIG. 38. Also how each intervention component links either directly or indirectly to capability components 12f, can be calculated by using the links added through the GUI 46. The application software can now use this information to calculate the cost of each capability component instance.

The timings of when capabilities will be delivered, as shown in FIG. 40, is used to calculate the timing of costs being incurred.

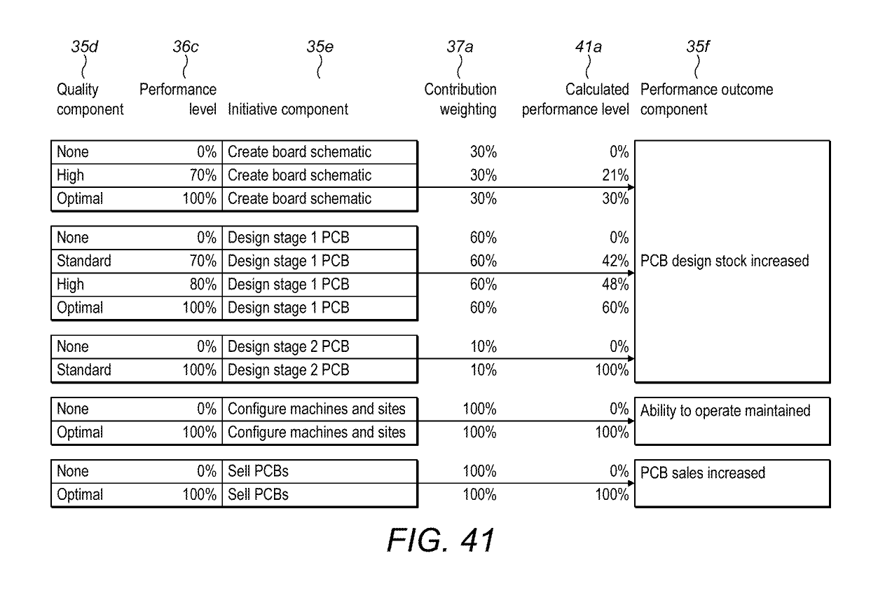

FIG. 41 shows the calculated performance levels 41a for the initiative components 35e and performance levels 36c. The calculated performance levels 41a are the product of the performance level 36c and the contribution weightings 37a between two components.

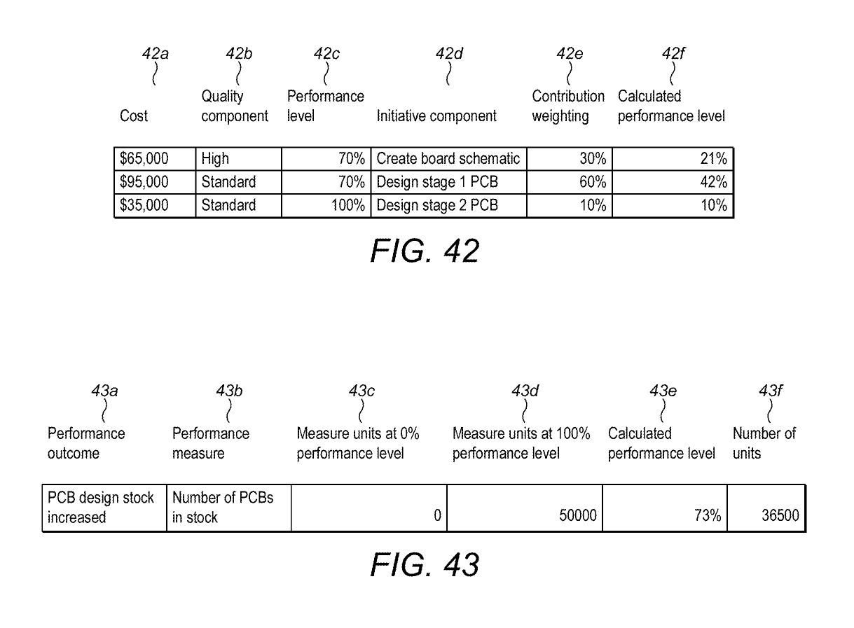

FIG. 42 shows three of the quality components 42b have been chosen as one scenario for the project and performance levels 42f for these choices calculated.

The three initiative components 42d link to the ‘PCB design stock increased’ performance outcome 43a as shown in FIG. 43, and these are I-1, I-2 and I-5 as shown in FIG. 46. A performance measure 43b titled ‘Number of PCBs in stock’ has a calculated performance level 43e of 73%. This is the sum of the calculated performance levels 42f from the initiative components 42d. As the measure units at 0% is 0 43c and at 100% is 50000 43d then the estimated number of units is 36500 43f which is 73% of 50000.

These calculations are for one phase as the performance level can change over the phases. The number of units is calculated for each measure for each phase and displayed through the GUI.

The calculations made by the application software provide estimates of cost, capability performance levels and performance measure units (the estimated cost, capability and benefits of the project).

In FIG. 44 summary optimization information is shown for the performance outcome component ‘Revenue from PCB sales increased’ O-4 as shown in FIG. 46.

There are five instances of initiative components shown in FIG. 46. These are I-1, I-2, I-3, I-4 and I-5 and they contribute to O-1, O-2 and O-3.

Identifying from FIG. 40 which quality components are selected 35d for each initiative component instance 35e allows the costs of the contributing intervention components 35a and 35b to be calculated.

As shown in FIG. 42 for I-1, I-2 and I-5 the quality component interventions chosen are High, Standard and Standard 42b with their costs calculated 42a.

For I-3 and I-4 there is only one capability component linked to each of them. These will be used with the costs from 36d, 36e and 36f.

FIG. 44 shows these summed costs 44a with the calculated performance levels 44e. Each performance level 44e is the product of performance level and contribution weighting 44d.

The performance level 44h for the outcome O-4 is the sum of the three performance outcome components contributing to it. As the contribution types are ‘accumulation’, the sum of the calculated performance levels is generated 44h.

The units forecast for the performance measure component is now generated. This is the value that is 89% 44h between values of $500,000 37g and $20,000,000 37h which is $17,394,000 44g. The difference between $17,394,000 44g and the baseline value $500,000 37g is the level of project benefit expected for the forecast cost of $479,000 44a. Additional costs could be added to the cost total, for example from Risk components, but they are not included in this example.

The project manager may now wish to return to the definition unit 1b to amend the design with this initial insight or use the optimization unit 1c to generate alternatives. The project manager in this example has set the optimization criteria to optimize the units forecast for the ‘PCB Revenue’ measure performance component 44g of the ‘Revenue from PCB sales increased’ performance outcome O-1.

A copy of the project design is stored in the design optimize storage 1i and descriptor changes made to those descriptors that can be auto-changed. An example of the change impacting the PCB Revenue is shown in FIG. 45 where the performance level 45a has been increased by 1%. This changes the calculated value for performance level 45b to 30% and the units forecast 45d. The difference forecast by this change is 45d subtracted from 44g with a net increase in PCB revenue of $78,000.

Details of the changes are stored in the design optimize storage and compared.

The project manager may analyze the design to assess those descriptors, components and contributions that are most sensitive to change, as identified by the optimization unit 1c. Different configurations of the design can be stored in the design model compare storage 1g and compared to understand the differences between them. The Optimization unit 1c looks at each component, contribution and descriptor and highlights the differences through multiple GUI mechanisms such as, but not limited to, colors, graphics and text. The project manager is able to apply new changes and the optimization unit 1c can then analyze, compare and report.

When the design is ready to be realized then a copy of all the forecast descriptors, components and contributions are stored in the detailed component information storage 1f and the forecast phases are stored in the phase template storage 1e. Every update, creation and deletion to the forecast design and actual descriptors are stored as updates. For example, actual descriptors in FIG. 38 are updated and impact of changes to the performance levels, costs, timings and performance outcome measures will be highlighted. The project manager is able to communicate expected changes to, for example, the value of PCB revenue in advance of the date when this is expected and to use the optimization unit 1c and analysis of the design to recommend changes to the design to address.

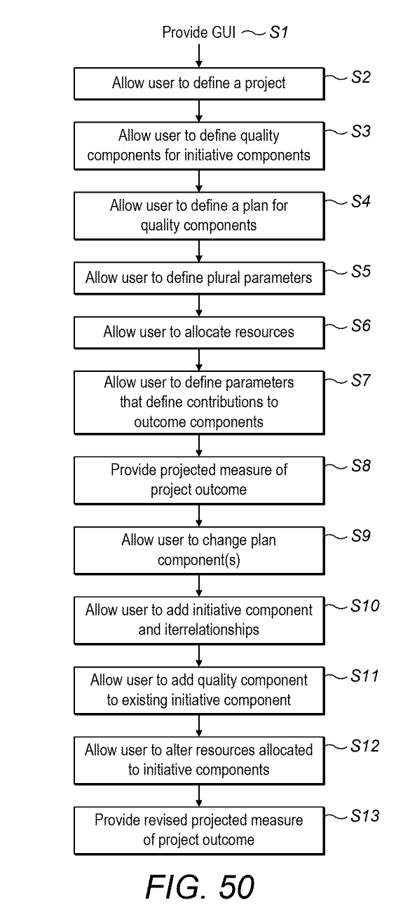

Key aspects of operation of the system described above can be summarized as follows, with reference to FIG. 50.

At step S1, the method provides a graphical user interface (GUI).

At step S2, a user is allowed to define, through the GUI, a project at least in terms of plural initiative components, plural outcome components, and interrelationships between the initiative components and the outcome components. A measure component may be associated with each of one or more of the plural outcome components, each measure components including information detailing how to measure outcome of the corresponding outcome component.

At step S3, the user is allowed to define, through the GUI, two or more quality components for each initiative component, each quality component comprising a performance level and resource costs associated with achieving the performance level. The resource costs for at least one quality component may include a time component. The time component may be a duration relating to a time to completion of the associated initiative component.

At step S4, the software may allow the user to define, through the GUI, a plan for each of at least one quality component, the plan comprising multiple components each having associated therewith at least a resource cost.

At step S5, the user is allowed to define, through the GUI, plural parameters associated with the project, the parameters including performance levels and resource costs for each of at least two quality components.

At step S6, the user is allowed to allocate, through the GUI, resources to each of the initiative components.

At step S7, the software may allow the user to define, through the GUI, parameters that define contributions to the outcome component that are provided by the initiative components and/or outcome components connected to the inputs of the at least one outcome component. Here, at least one of the outcome components is defined to include inputs from at least two initiative components and/or outcome components. The software may allow the user to alter the parameters through the GUI.

At step S8, the software then provides a projected measure of project outcome based on the allocated resources.

If the user defined a plan for each of at least one quality component, the software at step S9 allows the user to change one or more of the multiple components of the plan.

At step S10, the user may be allowed to add, through the GUI, at least one new initiative component and one or more interrelationships between the new initiative component and the existing initiative components and the existing outcome components. This may comprise allowing the user to choose, through the GUI, at least one initiative component from a library of initiative components.

At step S11, the user may be allowed to add, through the GUI, at least one new quality component to an existing initiative component, each new quality component comprising a performance level and resource costs associated with achieving the performance level.

At step S12, the user is allowed to alter, through the GUI, the resources allocated to the initiative components. This may comprise allowing the user to alter one or more resource cost parameters.

At step S13, the software then provides revised projected measure of project outcome based on the altered resource allocations.

It should be understood, of course, that the foregoing relates to exemplary embodiments and that modifications may be made without departing from the spirit and scope of the invention as set forth in the following claims.

1. A computer-implemented method, the method comprising:
providing a graphical user interface (GUI);
allowing a user to define, through the GUI, a project at least in terms of plural initiative components, plural outcome components, and interrelationships between the initiative components and the outcome components;
allowing the user to define, through the GUI, two or more quality components for each initiative component, each quality component comprising a performance level and resource costs associated with achieving the performance level;
allowing the user to define, through the GUI, plural parameters associated with the project, the parameters including performance levels and resource costs for each of at least two quality components;
allowing the user to allocate, through the GUI, resources to each of the initiative components;
providing a projected measure of project outcome based on the allocated resources;
allowing the user to alter, through the GUI, the resources allocated to the initiative components; and
providing revised projected measure of project outcome based on the altered resource allocations.

2. A method as claimed in claim 1, wherein at least one of the outcome components is defined to includes inputs from at least two initiative components and/or outcome components, the method comprising allowing the user to define, through the GUI, parameters that define contributions to the outcome component that are provided by the initiative components and/or outcome components connected to the inputs of the at least one outcome component; and allowing the user to alter, through the GUI, the parameters.

3. A method as claimed in claim 1, wherein the resource costs for at least one quality component include a time component.

4. A method as claimed in claim 3, wherein the time component is a duration relating to a time to completion of the associated initiative component.

5. A method as claimed in claim 1, comprising allowing the user to define, through the GUI, a plan for each of at least one quality component, the plan comprising multiple components each having associated therewith at least a resource cost.

6. A method as claimed in claim 5, comprising, subsequent to providing a projected measure of project outcome based on the plural parameters, allowing the user to change one or more of the multiple components of the plan.

7. A method as claimed in claim 1, wherein allowing the user to alter, through the GUI, one or more of the plural parameters associated with the project comprises allowing the user to alter, through the GUI, one or more resource cost parameters.

8. A method as claimed in claim 1, comprising, subsequent to providing a projected measure of project outcome based on the plural parameters, allowing the user to add, through the GUI, at least one new initiative component and one or more interrelationships between the new initiative component and the existing initiative components and the existing outcome components.

9. A method as claimed in claim 1, wherein allowing the user to alter, through the GUI, the resources allocated to the initiative components comprises allowing the user to select one of a number of items, for instance an intervention component, a capability component or a quality component, associated with the initiative component, each item having associated resource costs.

10. A method as claimed in claim 1, comprising, subsequent to providing a projected measure of project outcome based on the plural parameters, allowing the user to add, through the GUI, at least one new quality component to an existing initiative component, each new quality component comprising a performance level and resource costs associated with achieving the performance level.

11. A method as claimed in claim 1, comprising allowing the user to specify, through the GUI, a measure of projected outcome, and adjusting one or more of the plural parameters associated with the project so as to achieve the specified measure of project outcome at minimum resource cost.

12. A method as claimed in claim 1, comprising allowing the user to specify, through the GUI, a resource cost, and adjusting one or more of the plural parameters associated with the project so as to achieve an optimum measure or project outcome at the specified resource cost.

13. A method as claimed in claim 1, comprising a measure component associated with each of one or more of the plural outcome components, each measure components including information detailing how to measure outcome of the corresponding outcome component.

14. Apparatus, the apparatus having at least one processor and at least one memory having computer-readable code stored thereon which when executed controls the at least one processor to perform a method comprising:
providing a graphical user interface (GUI);
allowing a user to define, through the GUI, a project at least in terms of plural initiative components, plural outcome components, and interrelationships between the initiative components and the outcome components;
allowing the user to define, through the GUI, two or more quality components for each initiative component, each quality component comprising a performance level and resource costs associated with achieving the performance level;
allowing the user to define, through the GUI, plural parameters associated with the project, the parameters including performance levels and resource costs for each of at least two quality components;
allowing the user to allocate, through the GUI, resources to each of the initiative components;
providing a projected measure of project outcome based on the allocated resources;
allowing the user to alter, through the GUI, the resources allocated to the initiative components; and
providing revised projected measure of project outcome based on the altered resource allocations.

15. Apparatus as claimed in claim 14, wherein the computer-readable code when executed controls the at least one processor to provide a definition module, a realization module and an optimization module.

16. Apparatus as claimed in claim 15, wherein the definition unit is configured to perform one or more of:
manage definitions of the performance outcomes and how their achievement will be measured;
manage definitions of the interventions needed to create the capabilities for the performance outcomes to be achieved; and
manage definitions of different ways in which interventions and capabilities can be delivered to different levels of quality.

17. Apparatus as claimed in claim 15, wherein the definition unit is configured to obtain definitions of forecast durations, resources and costs of the interventions, and optionally also of sequential relationships between interventions that result in a change in capability.

18. Apparatus as claimed in claim 15, wherein the definition unit is configured to obtain definitions of the performance outcomes and their relative importance.

19. Apparatus as claimed in claim 14, wherein at least one of the outcome components is defined to includes inputs from at least two initiative components and/or outcome components, and where the computer-readable code when executed controls the at least one processor to allow the user to define, through the GUI, parameters that define contributions to the outcome component that are provided by the initiative components and/or outcome components connected to the inputs of the at least one outcome component; and to allow the user to alter, through the GUI, the parameters.

20. A non-transitory computer-readable storage medium having stored thereon computer-readable code, which, when executed by computing apparatus, causes the computing apparatus to perform a method comprising:
providing a graphical user interface (GUI);
allowing a user to define, through the GUI, a project at least in terms of plural initiative components, plural outcome components, and interrelationships between the initiative components and the outcome components;
allowing the user to define, through the GUI, two or more quality components for each initiative component, each quality component comprising a performance level and resource costs associated with achieving the performance level;
allowing the user to define, through the GUI, plural parameters associated with the project, the parameters including performance levels and resource costs for each of at least two quality components;
allowing the user to allocate, through the GUI, resources to each of the initiative components;
providing a projected measure of project outcome based on the allocated resources;
allowing the user to alter, through the GUI, the resources allocated to the initiative components; and
providing revised projected measure of project outcome based on the altered resource allocations.
